(19) United States
(12) Patent Application Publication
(10) Pub. No.: US 2012/0206471 A1
(43) Pub. Date: Aug. 16, 2012

(54) SYSTEMS, METHODS, AND COMPUTER-READABLE MEDIA FOR MANAGING LAYERS OF GRAPHICAL OBJECT DATA

(75) Inventors: Matthew Jacob Sarnoff, San Francisco, CA (US); Conrad R. Carlen, Burlingame, CA (US)

(73) Assignee: Apple Inc., Cupertino, CA (US)

(21) Appl. No.: 13/029,090

(22) Filed: Feb. 16, 2011

Related U.S. Application Data
(60) Provisional application No. 61/442,011, filed on Feb. 11, 2011.

(51) Int. Cl. G06T 11/00

(52) U.S. Cl. 345/581

(57) ABSTRACT

Systems, methods, and computer-readable media for managing layers of graphical object data are provided. For example, a graphical display system may be configured to implicitly manage various graphical object layers. In some embodiments, any new graphical object of a first type of graphical object may be generated in a current top layer of a stack when the current top layer is associated with the first type of graphical object. However, when the current top layer of the stack is not associated with the first type of graphical object, any new graphical object of the first type of graphical object may be generated in a new top layer of the stack. Moreover, any new graphical object of a second type of graphical object may similarly be generated in a new top layer of the stack.

### CROSS-REFERENCE TO RELATED APPLICATION

This application claims the benefit of U.S. Provisional Patent Application No. 61/442,011, filed Feb. 11, 2011, which is hereby incorporated by reference herein in its entirety.

### FIELD OF THE INVENTION

This can relate to systems, methods, and computer-readable media for generating graphical object data and, more particularly, to systems, methods, and computer-readable media for managing layers of graphical object data using an electronic device.

### BACKGROUND OF THE DISCLOSURE

Some electronic devices include a graphical display system for generating and presenting graphical objects, such as free-form drawing strokes, images, strings of text, and drawing shapes, on a display. A user of such devices may interact with the graphical display system via a user interface to create different graphical objects in different layers, which may overlap and be stacked in various orders when presented for display. However, the ways in which currently available electronic devices allow a user to manage various layers of graphical object data may be confusing or overwhelming.

### SUMMARY OF THE DISCLOSURE

Systems, methods, and computer-readable media for managing layers of graphical object data are provided.

Rather than explicitly creating and managing multiple graphical object layers (e.g., via a layers list that may be presented to and manipulated by a user), a graphical display system of an electronic device may be configured to utilize an implicit layer scheme that may be less confusing and less overwhelming to a casual user. Such an implicit layer management scheme may provide an interface that may not confuse a user with a layers list or that may not put a user in a situation where he or she may try to create a first type of graphical object content when a layer that is incompatible with the first type of graphical object content has been activated. Therefore, a graphical display system may be configured to follow one or more rules or principles when defining, selecting, and/or managing various graphical object layers, such that the simplicity of a basic drawing space application may be combined with the flexibility and non-destructive manipulation capabilities of a more advanced layering application.

For example, in some embodiments, a graphical display system may be configured to generate any new graphical object in the top-most layer of a layer stack presented for display to a user. Additionally or alternatively, the system may be configured to determine whether to incorporate a new graphical object into a new layer or into a pre-existing layer based on the particular type of the new graphical object and/or based on the particular type of graphical object that may be provided by the current top-most layer. That is, different types of graphical objects may be handled differently by the layer management processes of a graphical display system. For example, any new non-drawing stroke graphical object may be created in a new layer and that new layer may be made the top-most layer in the layer stack. Moreover, unless the current top-most layer is a drawing stroke layer, any new drawing stroke graphical object may be created in a new layer and that new layer may be made the top-most layer. Therefore, in some embodiments, only if the current top-most layer is a drawing stroke layer, may a graphical display system be configured to create any new drawing stroke graphical object in that pre-existing current top-most layer.

As another example of how a graphical display system may be configured such that the simplicity of a basic drawing space application may be combined with the flexibility and non-destructive manipulation capabilities of a more advanced layering application, certain types of graphical object layers may be automatically or optionally provided with certain tools, while other types of graphical object layers may not be provided with those tools. For example, each layered image graphical object may be provided with one or more control points that may be manipulated for resizing and/or moving the image graphical object layer in various ways along a workspace. As another example, each layered image graphical object may be provided with a toolbar that may allow a user to manipulate the graphical object layer in various other ways (e.g., by moving the layer up or down in the stack of layers, by adding another graphical object into the layer, and/or by modifying one or more properties of the graphical object of the layer).

In some embodiments, there is provided a method for managing graphical object data. The method may include determining the type of a new graphical object to be generated, and then generating the new graphical object in response to the determination. For example, in response to determining that the new graphical object is a second type of graphical object, the method may include generating the new graphical object in a new layer and positioning the new layer at the top of a stack. However, in response to determining that the new graphical object is a first type of graphical object, the method may include determining if the top layer in the stack is associated with the first type of graphical object. Then, in response to determining that the top layer in the stack is associated with the first type of graphical object, the method may include generating the new graphical object in the top layer in the stack. However, in response to determining that the top layer in the stack is not associated with the first type of graphical object, the method may include generating the new graphical object in a new layer and positioning the new layer at the top of the stack.

For example, the first type of graphical object may include a drawing stroke graphical object and the second type of graphical object may include an image graphical object. In some embodiments, the method may determine that the top layer in the stack is associated with the first type of graphical object by determining that the top layer in the stack was initially generated to include an initial graphical object of the first type of graphical object. Alternatively, the method may determine that the top layer in the stack is associated with the first type of graphical object by determining that the top layer in the stack includes an existing graphical object of the first type of graphical object. In yet other embodiments, the method may determine that the top layer in the stack is associated with the first type of graphical object by determining that the top layer in the stack includes at least one existing graphical object and by then determining that each one of the existing graphical objects is of the first type of graphical object. The method may also include presenting the generated new graphical object in its layer on a display. In such embodiments, the method may also include removing at least one previously presented layer tool from the display. Alternatively, in response to determining that the new graphical object is the second type of graphical object, the method may also include presenting on the display at least one new layer tool that is associated with the layer of the new graphical object.

In other embodiments, there is provided another method for managing graphical object data. The method may include presenting multiple graphical object layers in a stack on a display and receiving a selection of a first graphical object layer of the multiple graphical object layers. The method may also include determining if the first graphical object layer is associated with a first type of graphical object, and then enabling the first graphical object layer based on the determination. In some embodiments, the method may also include activating the first graphical object layer before the enabling, and the activating may include removing at least one previously presented layer tool from the display or visually distinguishing the first graphical object layer from the other graphical object layers on the display.

For example, in some embodiments, the first graphical object layer may include at least one graphical object of the first type of graphical object, and, in response to determining that the first graphical object layer is associated with the first type of graphical object, the enabling may include enabling the editing of the at least one graphical object of the first type of graphical object. Alternatively, the enabling may include enabling the editing of the at least one graphical object of the first type of graphical object only in response to determining that the first graphical object layer is associated with the first type of graphical object and that the first graphical object layer is the top layer in the stack. In yet other embodiments, the first graphical object layer may include at least one graphical object, and, in response to determining that the first graphical object layer is not associated with the first type of graphical object, the enabling may include presenting on the display at least one layer tool that is associated with the first graphical object layer. This presenting may include at least one of enabling the first graphical object layer to be actively moved along the stack, enabling the first graphical object layer to be actively moved along the display, and enabling a new graphical object to be created in the first graphical object layer. Alternatively, the first graphical object layer may include an initial boundary, and the enabling may include enabling a new graphical object in the first graphical object layer to be created within the initial boundary or beyond the initial boundary.

In yet other embodiments, there is provided a method for managing graphical object data that may include presenting multiple graphical object layers in a stack on a display. The method may also include receiving a selection of a first graphical object layer of the multiple graphical object layers, and the first graphical object layer may include a first graphical object. The method may also include creating a new graphical object in the selected first graphical object layer and then manipulating the first graphical object layer. The manipulating may include manipulating the first graphical object and the new graphical object. In some embodiments, the first graphical object may be an image graphical object and the new graphical object may be a drawing stroke graphical object.

For example, creating the new graphical object may include re-defining a portion of the first graphical object layer that may have been previously defined by the first graphical object. In other embodiments, creating the new graphical object may include expanding a boundary of the first graphical object layer. Manipulating the first graphical object layer may also include moving the first graphical object layer along the stack, which may include moving the first graphical object and the new graphical object with the first graphical object layer along the stack. Alternatively, manipulating the first graphical object layer may also include moving the first graphical object layer along the display, which may include moving the first graphical object and the new graphical object with the first graphical object layer along the display. As yet another alternative, manipulating the first graphical object layer may also include resizing the first graphical object layer, which may include resizing the first graphical object and the new graphical object with the first graphical object layer.

In still yet other embodiments, there is provided a graphical display system that may include a graphical object generating module. The graphical object generating module may receive input information defining a new graphical object to be generated, and may then determine if the new graphical object to be generated is a first type of graphical object based on the received input information. The graphical object generating module may also generate a new top layer in a stack and may generate the new graphical object in the new top layer when the generating module determines that the new graphical object is not of the first type. The graphical object generating module may also determine if the current top layer in the stack is associated with the first type of graphical object when the generating module determines that the new graphical object is of the first type. Then, the graphical object generating module may generate the new graphical object in the current top layer when the generating module determines that the current top layer is associated with the first type of graphical object. Alternatively, the graphical object generating module may generate a new top layer in the stack and may generate the new graphical object in the new top layer when the generating module determines that the current top layer is not associated with the first type of graphical object. The graphical display system may also include a graphical processing module that may render the generated new graphical object in its layer on a display.

In still yet other embodiments, there is provided computer-readable media for controlling an electronic device, that may include computer-readable code recorded thereon for generating any new graphical object of a first type of graphical object in a current top layer of a stack when the current top layer is associated with the first type of graphical object, generating any new graphical object of the first type of graphical object in a new top layer of the stack when the current top layer of the stack is not associated with the first type of graphical object, and generating any new graphical object of a second type of graphical object in a new top layer of the stack.

### BRIEF DESCRIPTION OF THE DRAWINGS

The above and other aspects of the invention, its nature, and various features will become more apparent upon consideration of the following detailed description, taken in conjunction with the accompanying drawings, in which like reference characters refer to like parts throughout, and in which:

FIG. 1 is a schematic view of an illustrative electronic device for managing layers of graphical object data, in accordance with some embodiments of the invention;

FIG. 2 is a schematic view of an illustrative portion of the electronic device of FIG. 1, in accordance with some embodiments of the invention;

FIGS. 3A-3P are front views of the electronic device of FIGS. 1 and 2, presenting exemplary screens of displayed graphical data, in accordance with some embodiments of the invention; and

FIG. 4 is a flowchart of an illustrative process for managing layers of graphical object data, in accordance with some embodiments of the invention.

### DETAILED DESCRIPTION OF THE DISCLOSURE

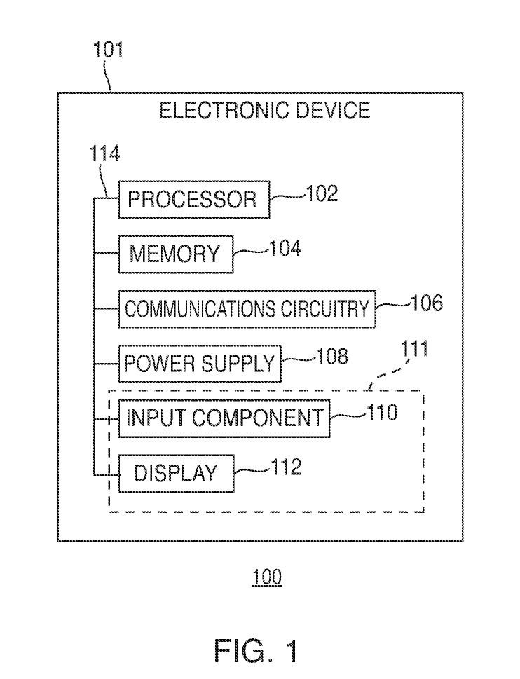

Systems, methods, and computer-readable media for managing layers of graphical object data are provided and described with reference to FIGS. 1-4.

FIG. 1 is a schematic view of an illustrative electronic device 100 for managing layers of graphical object data in accordance with some embodiments of the invention. Electronic device 100 may be any portable, mobile, or hand-held electronic device configured to manage layers of graphical object data wherever the user travels. Alternatively, electronic device 100 may not be portable at all, but may instead be generally stationary. Electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet, server, etc.), monitor, television, stereo equipment, set up box, set-top box, boom box, modem, router, printer, and combinations thereof. In some embodiments, electronic device 100 may perform a single function (e.g., a device dedicated to managing layers of graphical object data) and, in other embodiments, electronic device 100 may perform multiple functions (e.g., a device that manages layers of graphical object data, plays music, and receives and transmits telephone calls).

Electronic device 100 may include a processor or control circuitry 102, memory 104, communications circuitry 106, power supply 108, input component 110, and display 112. Electronic device 100 may also include a bus 114 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 1. For example, electronic device 100 may include motion-sensing circuitry, a compass, positioning circuitry, or several instances of the components shown in FIG. 1. For the sake of simplicity, only one of each of the components is shown in FIG. 1.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may store media data (e.g., music and image files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications circuitry 106 may be provided to allow device 100 to communicate with one or more other electronic devices or servers using any suitable communications protocol. For example, communications circuitry 106 may support Wi-Fi (e.g., an 802.11 protocol), Ethernet, Bluetooth™, high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), any other communications protocol, or any combination thereof. Communications circuitry 106 may also include circuitry that can enable device 100 to be electrically coupled to another device (e.g., a host computer or an accessory device) and communicate with that other device, either wirelessly or via a wired connection.

Power supply 108 may provide power to one or more of the components of device 100. In some embodiments, power supply 108 can be coupled to a power grid (e.g., when device 100 is not a portable device, such as a desktop computer). In some embodiments, power supply 108 can include one or more batteries for providing power (e.g., when device 100 is a portable device, such as a cellular telephone). As another example, power supply 108 can be configured to generate power from a natural source (e.g., solar power using solar cells).

One or more input components 110 may be provided to permit a user to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, proximity sensor, light detector, motion sensors, and combinations thereof. Each input component 110 can be configured to provide one or more dedicated control functions for making selections or issuing commands associated with operating device 100.

Electronic device 100 may also include one or more output components that may present information (e.g., graphical, audible, and/or tactile information) to a user of device 100. An output component of electronic device 100 may take various forms, including, but not limited to, audio speakers, headphones, audio line-outs, visual displays, antennas, infrared ports, rumblers, vibrators, or combinations thereof.

For example, electronic device 100 may include display 112 as an output component. Display 112 may include any suitable type of display or interface for presenting visual data to a user. In some embodiments, display 112 may include a display embedded in device 100 or coupled to device 100 (e.g., a removable display). Display 112 may include, for example, a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or combination thereof. Alternatively, display 112 can include a movable display or a projecting system for providing a display of content on a surface remote from electronic device 100, such as, for example, a video projector, a head-up display, or a three-dimensional (e.g., holographic) display. As another example, display 112 may include a digital or mechanical viewfinder, such as a viewfinder of the type found in compact digital cameras, reflex cameras, or any other suitable still or video camera.

In some embodiments, display 112 may include display driver circuitry, circuitry for driving display drivers, or both. Display 112 can be operative to display content (e.g., media playback information, application screens for applications implemented on electronic device 100, information regarding ongoing communications operations, information regarding incoming communications requests, device operation screens, etc.) that may be under the direction of processor 102. Display 112 can be associated with any suitable characteristic dimensions defining the size and shape of the display. For example, the display can be rectangular or have any other polygonal shape, or alternatively can be defined by a curved or other non-polygonal shape (e.g., a circular display). Display 112 can have one or more primary orientations for which an interface can be displayed, or can instead or in addition be operative to display an interface along any orientation selected by a user.

It should be noted that one or more input components and one or more output components may sometimes be referred to collectively herein as an input/output (“I/O”) component or I/O interface (e.g., input component 110 and display 112 as I/O component or I/O interface 111). For example, input component 110 and display 112 may sometimes be a single I/O component 111, such as a touch screen, that may receive input information through a user's touch of a display screen and that may also provide visual information to a user via that same display screen.

Processor 102 of device 100 may include any processing circuitry operative to control the operations and performance of one or more components of electronic device 100. For example, processor 102 may be used to run operating system applications, firmware applications, media playback applications, media editing applications, or any other application. In some embodiments, processor 102 may receive input signals from input component 110 and/or drive output signals through display 112. Processor 102 may load a user interface program (e.g., a program stored in memory 104 or another device or server) to determine how instructions or data received via an input component 110 may manipulate the way in which information is stored and/or provided to the user via an output component (e.g., display 112). Electronic device 100 (e.g., processor 102, memory 104, or any other components available to device 100) may be configured to process graphical data at various resolutions, frequencies, intensities, and various other characteristics as may be appropriate for the capabilities and resources of device 100.

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 110 may be an independent keyboard or mouse within its own housing that may wirelessly or through a wire communicate with processor 102, which may be provided within its own housing).

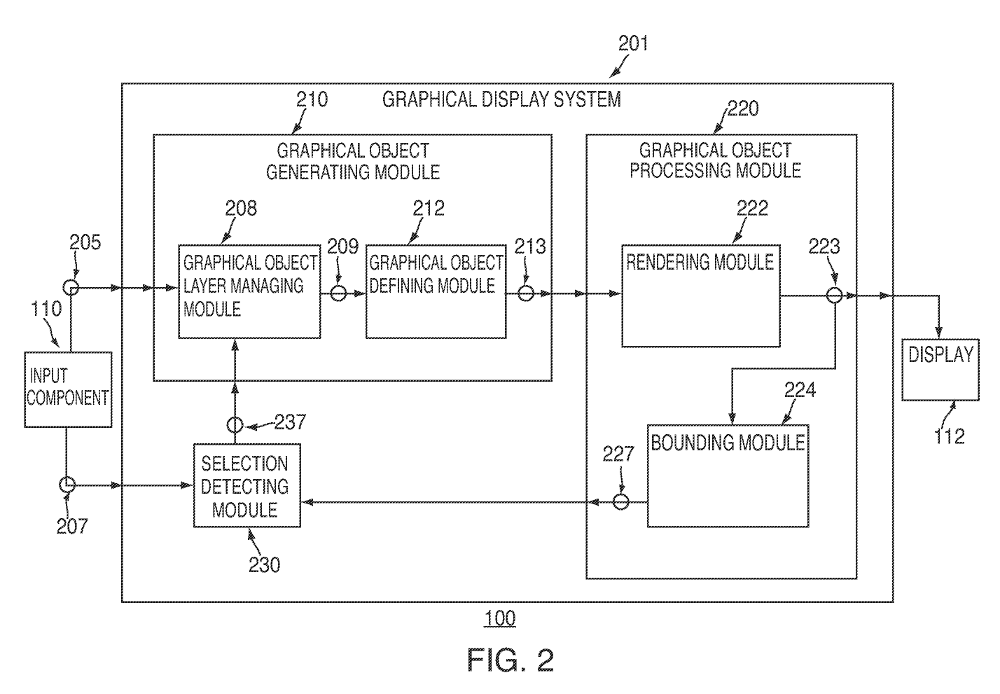

FIG. 2 shows a schematic view of a graphical display system 201 of electronic device 100 that may be provided to generate and manipulate graphical data for presentation to a user. For example, in some embodiments, graphical display system 201 may generate and manipulate graphical data representations of two-dimensional and/or three-dimensional objects that may define at least a portion of a visual screen of information to be presented as an image on a display, such as display 112. Graphical display system 201 may be configured to generate and manipulate realistic animated images in real time (e.g., using about 30 or more screens or frames per second).

As shown in FIG. 2, for example, graphical display system 201 may include a graphical object generating module 210 that may define and generate at least a portion of the graphical contents of each of the screens to be rendered for display. Such graphical screen contents may be based on the one or more applications being run by electronic device 100 as well as any input instructions being received by device 100 (e.g., via input component 110). The graphical screen contents can include free-form drawing strokes, image content (e.g., photographic images), textual information (e.g., one or more alphanumeric characters in a text string), drawing shape objects, video data based on images of a video program, and combinations thereof. For example, an application run by electronic device 100 may be any suitable application that may provide a virtual canvas or workspace on which a user may create and manipulate graphical objects, such as free-form drawing strokes, images, drawing shapes, and text strings (e.g., Photoshop™ or Illustrator™ by Adobe Systems Incorporated or Microsoft Paint™ by Microsoft Corporation). Graphical object generating module 210 may define and generate at least some of these types of graphical objects to be rendered for display by graphical display system 201. For example, graphical object generating module 210 may define and generate drawing stroke graphical objects, image graphical objects, drawing shape graphical objects, and/or text string graphical objects to be rendered for display by graphical display system 201 on display 112 of electronic device 100.

Graphical object data may generally be represented in two ways or as two types of data (i.e., pixel data and analytical graphic objects or “vector objects”). Graphical object data of the pixel data type may be collections of one or more pixels (e.g., samples of color and/or other information including transparency and the like) that may be provided in various raster or bitmap layers on a canvas or workspace. On the other hand, graphical object data of the vector object type may be an abstract graphic entity (e.g., such that its appearance, position, and orientation in a canvas or workspace may be defined analytically through geometrical formulas, coordinates, and the like). Some pixel data may be provided with additional position and orientation information that can specify the spatial relationship of its pixels relative to a canvas or workspace containing the pixel data, which may be considered a bitmap vector graphic object when placed in a vector graphics document. Before the application of any additional transformation or deformation, such a bitmap vector object may be equivalent to a rectangular vector object texture-mapped to the pixel data. While at least some of the embodiments herein may be specifically described with reference to graphical object data of the pixel data type, it is to be understood that at least some of the systems, methods, and computer-media described herein may additionally or alternatively manage layers of graphical object data of the vector object type and/or of some combination of the pixel data type and the vector object type.

Graphical object generating module 210 may define and generate various types of graphical objects of an application document or work, such as drawing stroke graphical objects, image graphical objects, drawing shape graphical objects, and/or text string graphical objects, which may be rendered for display by graphical display system 201 on display 112 of electronic device 100. In some embodiments, a document of graphical object data may be generated and presented by system 201 such that each graphical object may be provided by its own layer, and such that at least some layers may be managed in various ways with respect to other layers. Such a layered approach may allow a user to create and manipulate many graphical objects with respect to one another for making original works of art.

Therefore, as shown in FIG. 2, for example, graphical object generating module 210 may include a graphical object layer managing module 208 and a graphical object defining module 212. Graphical object layer managing module 208 may be configured to initially define and generate each layer of an application document, and graphical object defining module 212 may be configured to define and generate at least one graphical object in each layer. In some embodiments, layer managing module 208 may also be configured to manage the ways in which various graphical object layers may be manipulated and stacked with respect to one another. Each layer may be an individual bitmap, pixmap, or raster layer of pixels, and each layer may be independently rendered for display. A layer may be defined to have an initial size or set of geometric bounds, and the pixels of a layer may have initial color values. The map characteristics of a particular layer may vary based on the type of graphical object data to be provided in that layer (e.g., based on the type of graphical object defined and generated by graphical object defining module 212 for that particular layer).

Graphical object generating module 210 may receive graphical object input information 205 from various input sources for defining one or more graphical object properties of a graphical object that may be generated and presented on display 112. For example, such input sources may be the one or more applications being run by electronic device 100 and/or any user input instructions being received by device 100 (e.g., via input component 110, as shown in FIG. 2). In some embodiments, based on at least a portion of the received graphical object input information 205, layer managing module 208 may define and generate layered graphical object information 209 that may be indicative of a layer in which a new graphical object is to be provided. For example, based on the type of graphical object that may be defined by graphical object input information 205, layer managing module 208 may generate layered graphical object information 209 indicative of an existing layer (e.g., a layer that may have been previously defined by layer managing module 208). Alternatively, based on the type of graphical object that may be defined by graphical object input information 205, layer managing module 208 may generate layered graphical object information 209 indicative of a new layer (e.g., a layer that may be created by layer managing module 208 in response to the received graphical object input information 205). Moreover, based on the received graphical object input information 205, layered graphical object information 209 may also be indicative of at least some information that may be used by graphical object defining module 212 to define and generate a new graphical object to be provided in the indicated layer. Layer managing module 208 may then provide this layered graphical object information 209 to graphical object defining module 212.

Based on this layered graphical object information 209, graphical object defining module 212 may be configured to define and generate at least one new graphical object in the layer defined by layered graphical object information 209. For example, as shown in FIG. 2, graphical object defining module 212 may generate layered graphical object content 213, which may define not only the graphical object content of the layer indicated by layered graphical object information 209 but also the remaining content of that layer, if any. The content of a graphical object defined by layered graphical object content 213 may be any suitable type of graphical content, such as a drawing stroke, an image, a string of text, a drawing shape, and the like. In some embodiments, the graphical object content may be at least partially based on one or more graphical object properties defined by graphical object input information 205.

For example, when graphical object generating module 210 is generating a layered drawing stroke graphical object, graphical object input information 205 may define one or more drawing stroke properties. A drawing stroke graphical object may be considered a path along which a drawing stroke input tool (e.g., a stamp) may be applied. Such a drawing stroke input tool may define a particular set of pixel data to be applied on a display when the stamp is used for creating a drawing stroke graphical object along a defined trail. For example, such a trail may define a path on the display along which an associated drawing stroke input tool may repeatedly apply its pixel data for generating a drawing stroke graphical object on the display. Therefore, graphical object input information 205 may define one or more drawing stroke input tool properties and/or one or more trail properties for a particular drawing stroke graphical object. A stamp drawing stroke input tool may be defined by any suitable stamp property or set of stamp properties including, but not limited to, shape, size, pattern, orientation, hardness, color, transparency, spacing, and the like. A drawing stroke trail may be defined by any suitable trail property or set of trail properties including, but not limited to, length, path, and the like. Once drawing stroke graphical object input information 205 has been received, layer managing module 208 may identify an appropriate layer and graphical object defining module 212 may generate appropriate layered drawing stroke graphical object content 213, such as a particular pixel data set for a stamp applied along a particular trail in the identified layer.

As another example, when graphical object generating module 210 is generating a layered image graphical object, graphical object input information 205 may define one or more images. An image may be any suitable image file that can be imported into a layered graphical object document. Such an image may be defined by an address at which image data is stored (e.g., in memory 104 of device 100). An image file may be in any suitable format for providing image content to system 201 including, but not limited to, a JPEG file, a TIFF file, a PNG file, a GIF file, and the like. Once image graphical object input information 205 has been received, layer managing module 208 may identify an appropriate layer and graphical object defining module 212 may generate appropriate layered image graphical object content 213, such as an image file in the identified layer.

As another example, when graphical object generating module 210 is generating a layered text string graphical object, graphical object input information 205 may define one or more characters, as well as a selection of one or more properties that may be used to define various characteristics of the selected characters. For example, a text string character may be a letter, number, punctuation, or other symbol that may be used in the written form of one or more languages. Symbol characters may include, but are not limited to, representations from a variety of categories, such as mathematics, astrology, astronomy, chess, dice, ideology, musicology, economics, politics, religion, warning signs, meteorology, and the like. A property that may be used to define a characteristic of a text string character may include, but is not limited to, a font type (e.g., Arial or Courier), a character size, a style type (e.g., bold or italic), a color, and the like. Once text string graphical object input information 205 has been received, layer managing module 208 may identify an appropriate layer and graphical object defining module 212 may generate appropriate layered text string graphical object content 213, such as a string of one or more particular character glyphs in the identified layer.

As another example, when graphical object generating module 210 is generating a drawing shape graphical object, graphical object input information 205 may define a pre-defined shape (e.g., a box, a star, a heart, etc.) or a free-form drawing input indicative of a user-defined shape. Once drawing shape input information 205 has been received, layer managing module 208 may identify an appropriate layer and graphical object defining module 212 may generate appropriate layered drawing shape graphical object content 213, such as an appropriate boundary representation of the defined drawing shape in the identified layer.

Regardless of the type of graphical object to be created, a user may interact with one or more drawing applications running on device 100 via input component 110 to generate input information 205 for defining one or more of the graphical object properties. Alternatively or additionally, in other embodiments, an application running on device 100 may be configured to automatically generate at least a portion of input information 205 for defining one or more of the graphical object properties.

Rather than explicitly creating and managing multiple graphical object layers (e.g., via a layers list that may be presented to and manipulated by a user), system 201 may be configured to utilize an implicit layer scheme that may be less confusing and less overwhelming to a casual user. For although graphical object layers may have to be managed (e.g., to determine in which of many possible layers new graphical data is to be added), system 201 may handle layer management more implicitly (e.g., such that a user may never be confused by a layers list and/or such that a user may never be put in a situation where he or she tries to create a first type of graphical object content but an input tool for the first type of graphical object content does not work because a layer that is incompatible with the first type of graphical object content has been selected). Therefore, system 201 may be configured to follow one or more rules or principles when defining, selecting, and/or managing various graphical object layers, such that the simplicity of a basic drawing space application may be combined with the flexibility and non-destructive manipulation capabilities of a more advanced layering application.

For example, in some embodiments, system 201 may be configured to generate any new graphical object in the top-most layer of a stack of layers being displayed. Additionally or alternatively, system 201 may be configured to determine whether to incorporate a new graphical object into a new layer or into a pre-existing layer based on the particular type of the new graphical object and/or based on the particular type of graphical object that may be provided by the current top-most layer in the stack. That is, different types of graphical objects may be handled differently by the layer management processes of system 201. For example, system 201 may be configured to create any new non-drawing stroke graphical object in a new layer and then to make that new layer the top-most layer in the layer stack. Moreover, unless the current top-most layer is a drawing stroke layer, system 201 may also be configured to create any new drawing stroke graphical object in a new layer and then to make that new layer the top-most layer. Therefore, in some embodiments, only if the current top-most layer is a drawing stroke layer, may system 201 then be configured to create any new drawing stroke graphical object in that pre-existing current top-most layer.

As another example of how system 201 may be configured to follow one or more rules or principles when defining, selecting, and/or managing various graphical object layers, such that the simplicity of a basic drawing space application may be combined with the flexibility and non-destructive manipulation capabilities of a more advanced layering application, certain types of graphical object layers may be automatically or optionally provided with certain tools, while other types of graphical object layers may not be provided with those tools. For example, each layered image graphical object may be provided with one or more control points that may be manipulated for stretching, shrinking, and/or moving the graphical object layer in various ways along a workspace. As another example, each layered image graphical object may be provided with a toolbar that may allow a user to manipulate the graphical object layer in various other ways (e.g., by moving the layer up or down in the stack of layers, by adding another graphical object into the layer, and/or by modifying one or more properties of the graphical object of the layer). These are just some examples of rules or principles that system 201 may be configured to follow when defining, selecting, and/or managing various graphical object layers, such that a user may be provided with an easy to use implicit layering application interface that may share some functionalities with more explicit layer management programs.

As shown in FIG. 2, for example, graphical display system 201 may also include a graphical object processing module 220 that may process the layered graphical object content generated by graphical object generating module 210 (e.g., layered graphical object content 213) such that a layered graphical object may be presented to a user on display 112 of device 100. In some embodiments, as shown in FIG. 2, for example, graphical object processing module 220 may include a rendering module 222. Rendering module 222 may be configured to render the layered graphical screen content information for the layered graphical object content generated by graphical object generating module 210, and may therefore be configured to provide rendered layered graphical object data for presentation on display 112 (e.g., rendered layered graphical object data 223 based on layered graphical object content 213).

For example, rendering module 222 may be configured to perform various types of graphics computations or processing techniques and/or implement various rendering algorithms on the graphical object content generated by graphical object generating module 210 so that rendering module 222 may render the graphical data necessary to define at least a portion of the image to be displayed on display 112 (e.g., the graphical object portion of the image). Such processing may include, but is not limited to, matrix transformations, scan-conversions, various rasterization techniques, various techniques for three-dimensional vertices and/or three-dimensional primitives, texture blending, and the like.

Rendered graphical object data 223 generated by rendering module 222 may include one or more sets of pixel data, each of which may be associated with a respective pixel to be displayed by display 112 when presenting a layered graphical object portion of that particular screen's visual image to a user of device 100. For example, each of the sets of pixel data included in the rendered graphical object data generated by rendering module 222 may be correlated with coordinate values that identify a particular one of the pixels to be displayed by display 112, and each pixel data set may include a color value for its particular pixel as well as any additional information that may be used to appropriately shade or provide other cosmetic features for its particular pixel. A portion of this pixel data for rendered graphical object data 223 may represent at least a portion of the graphical object content 213 for a particular layer having at least one particular graphical object (e.g., a layer having a drawing stroke for a layered drawing stroke graphical object or a layer having an image for a layered image graphical object). The pixel data of rendered graphical object data 223 may represent at least a portion of graphical object content 213 for each one of multiple different layered graphical objects. The manner in which certain layers overlap or are stacked with respect to one another may be determined by certain information provided by content 213. Layer managing module 208 may control the order of different layers in the stack and rendering module 222 may present the layered graphical objects for display according to the layer management of layer managing module 208.

Rendering module 222 may be configured to transmit the pixel data sets of the rendered graphical object data for a particular screen to display 112 via any suitable process for presentation to a user. Moreover, rendering module 222 may transmit the rendered graphical object data 223 to a bounding module 224 of graphical object processing module 220. Based on the rendered graphical object data, bounding module 224 may generate bounding area information 227 that may be indicative of one or more particular areas of the screen presented by display 112. For example, bounding area information 227 may be indicative of the particular pixel area of a display screen that is presenting a particular graphical object of layered graphical object content 213. Bounding area information 227 may be compared with user input information (e.g., selection input information 207) indicative of a user interaction with a displayed layered graphical object, and such a comparison may help determine with which particular portion of which particular graphical object the user is intending to interact.

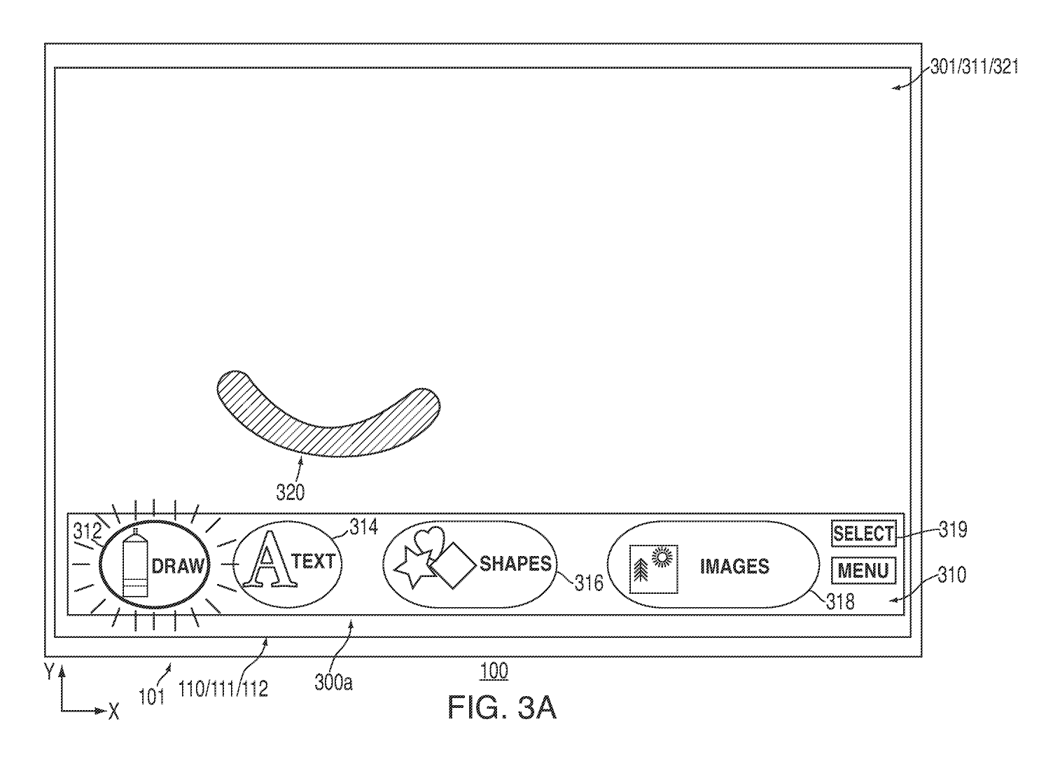

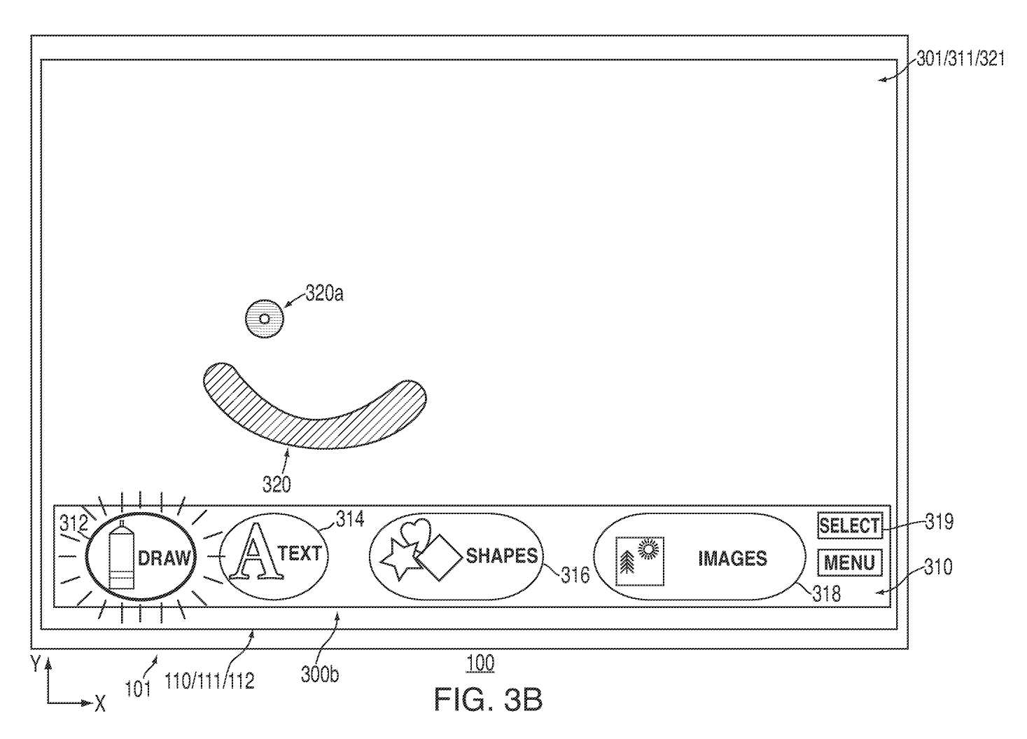

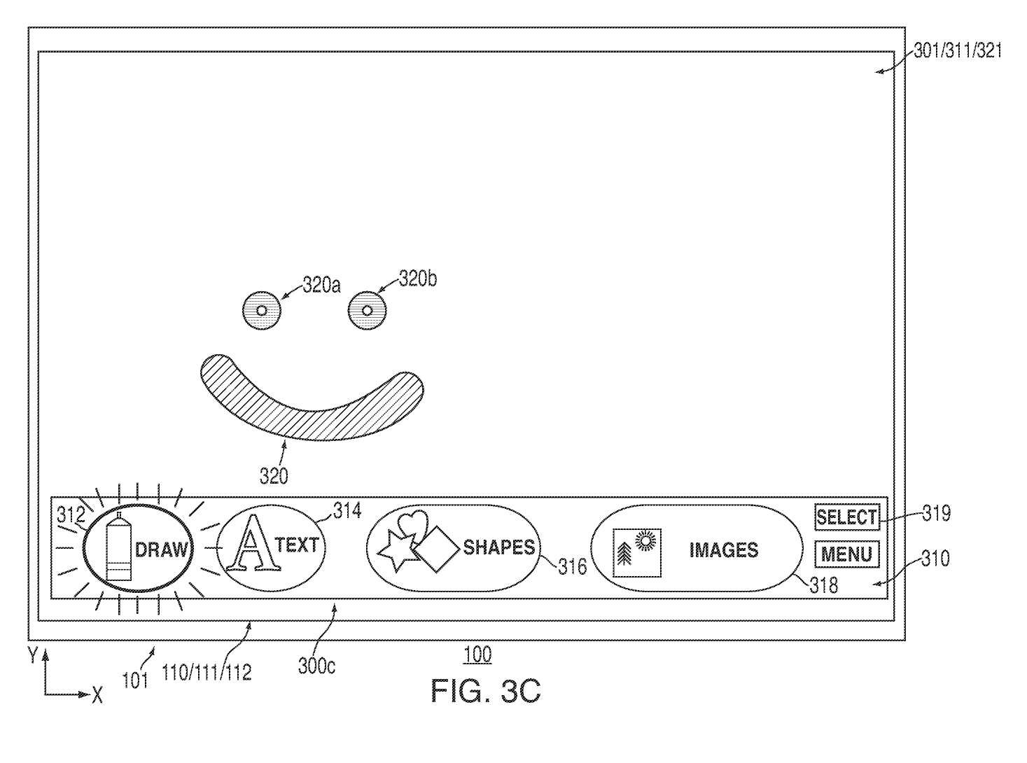

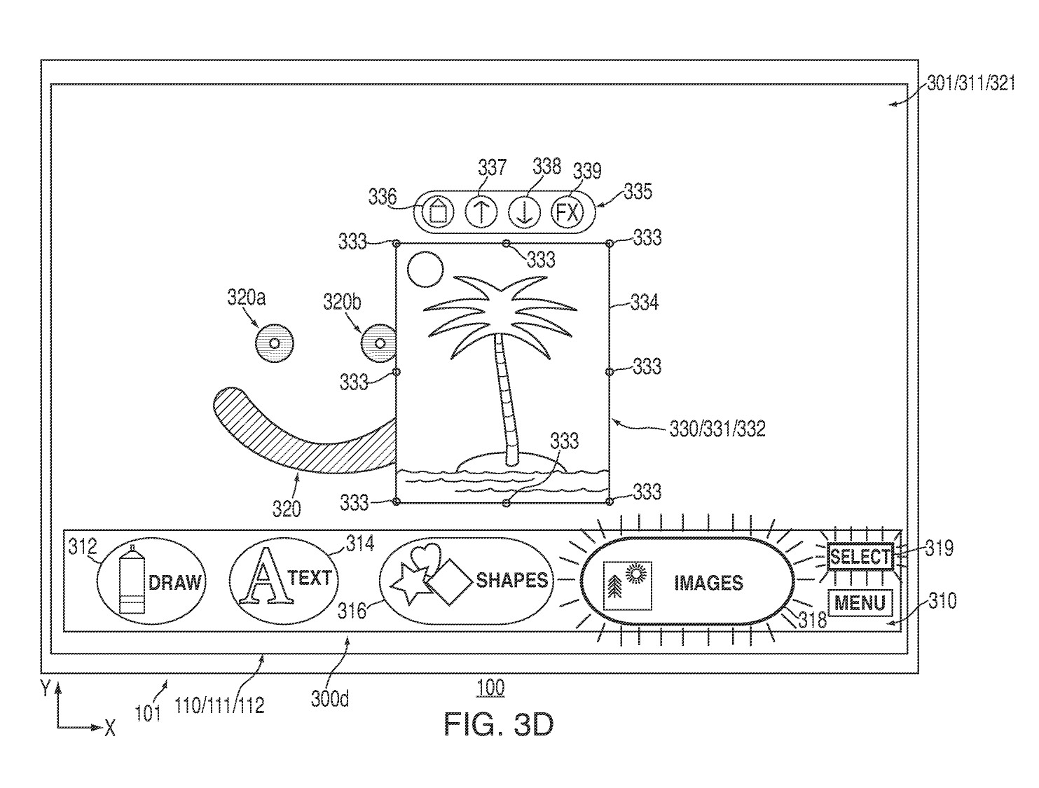

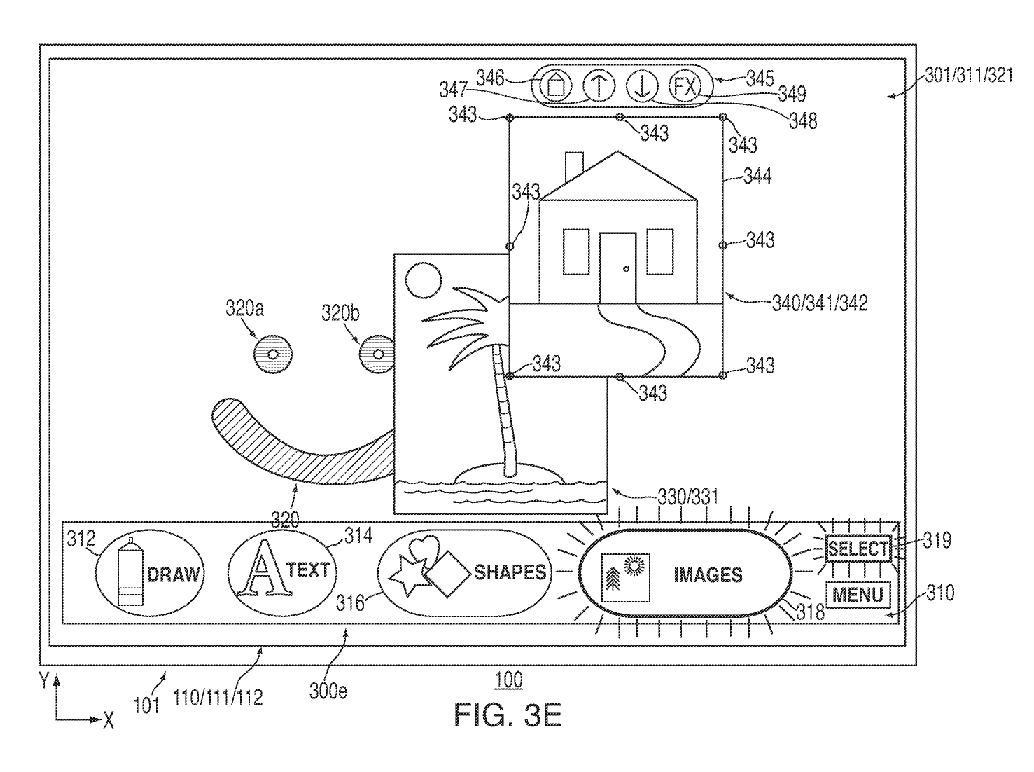

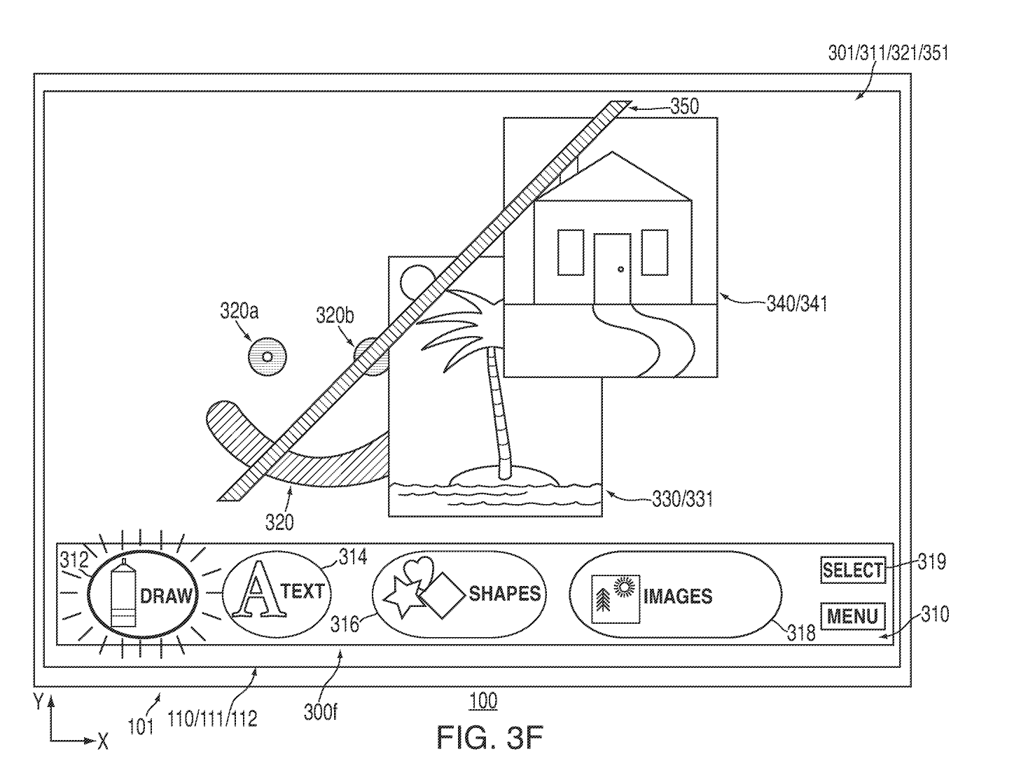

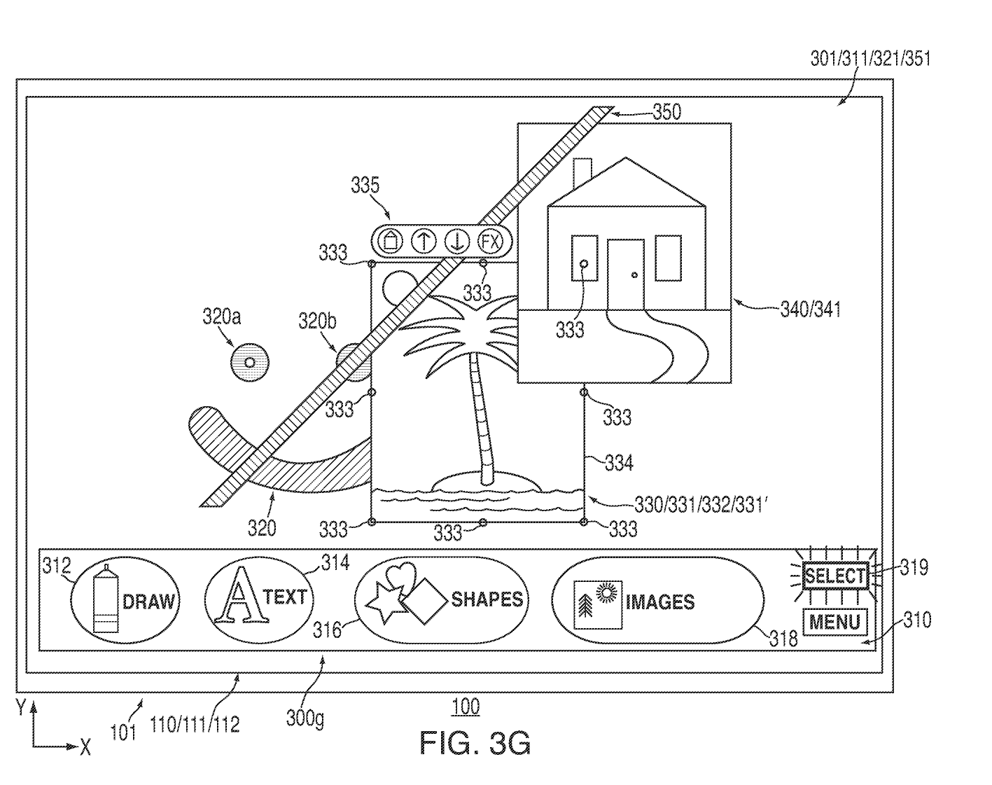

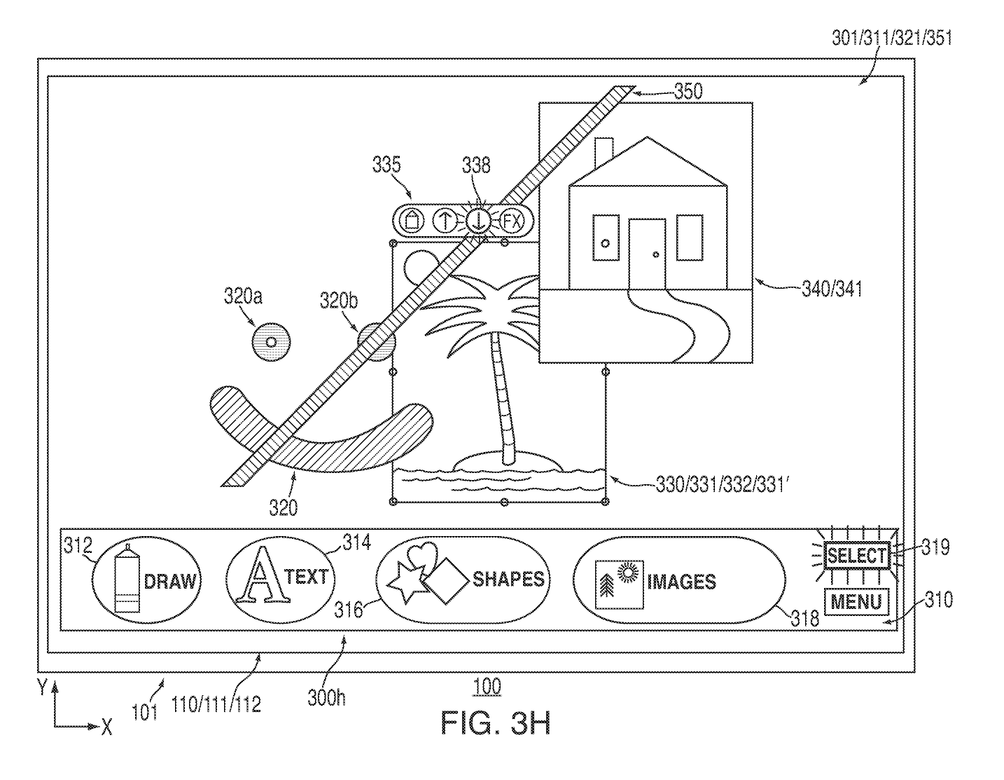

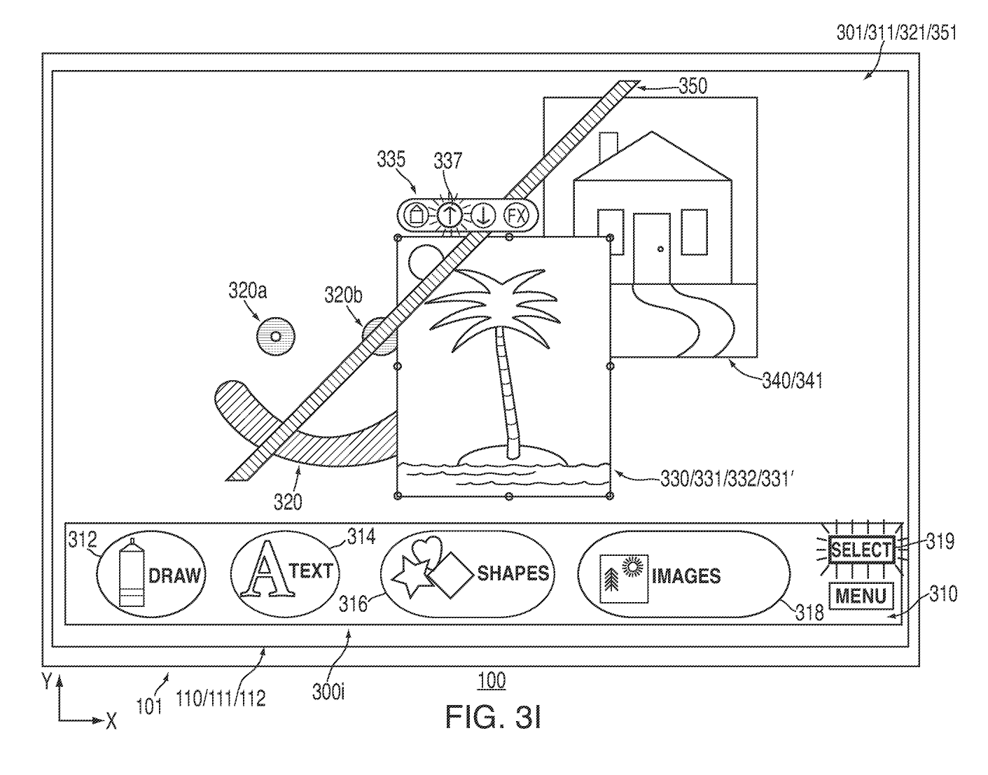

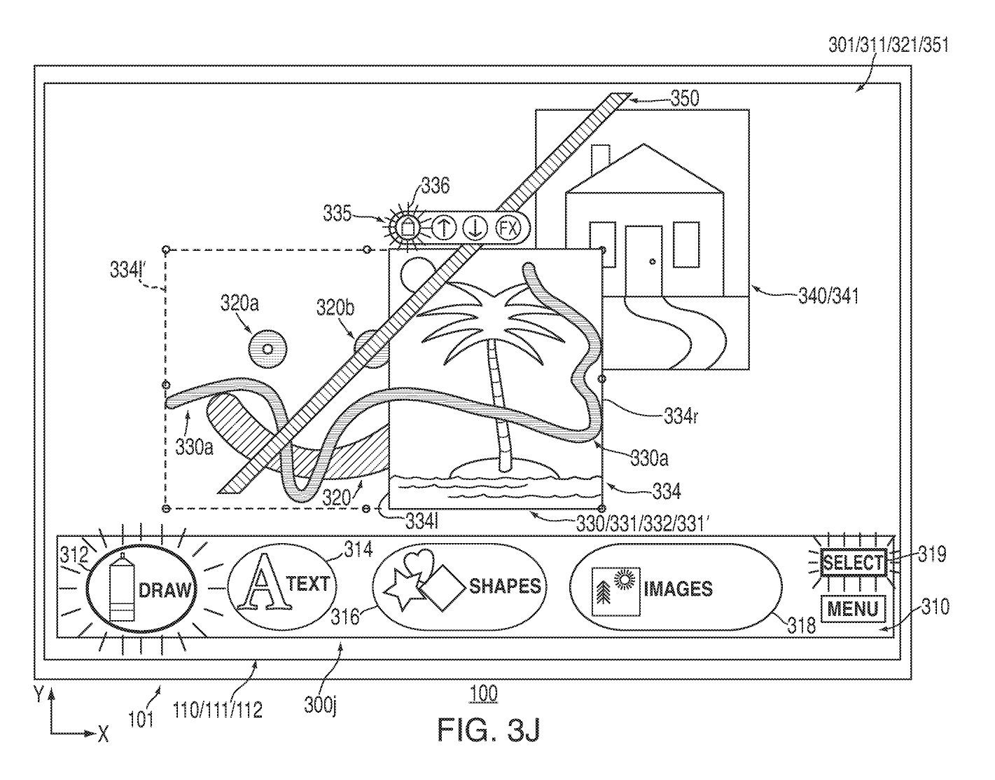

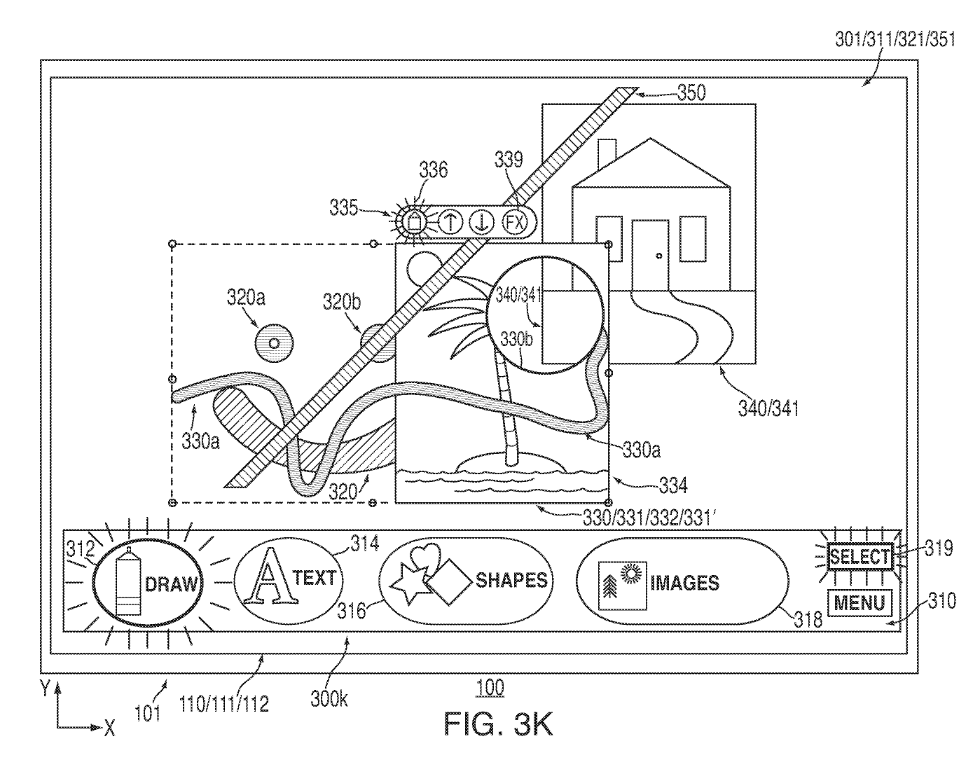

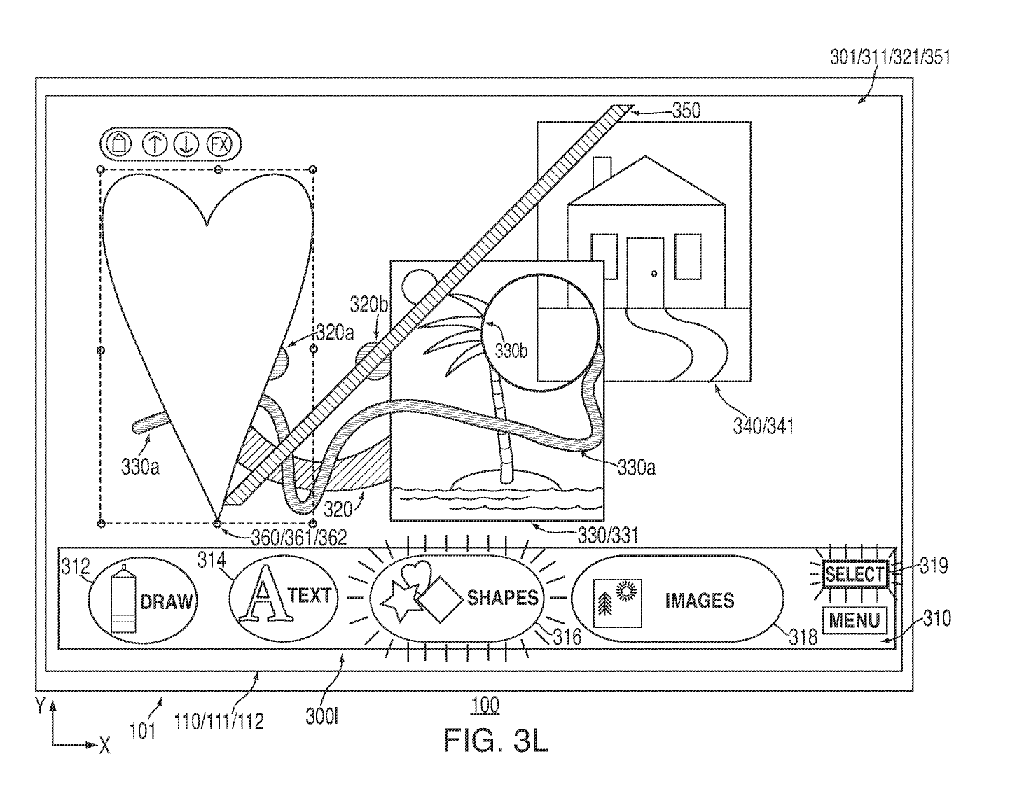

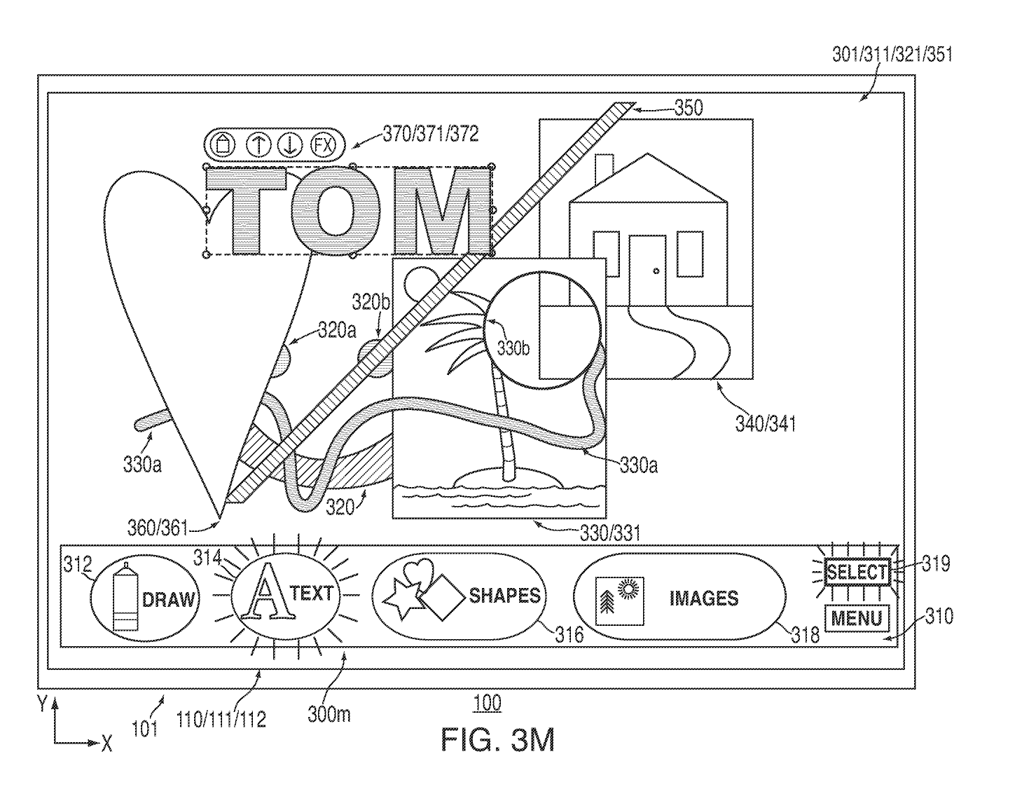

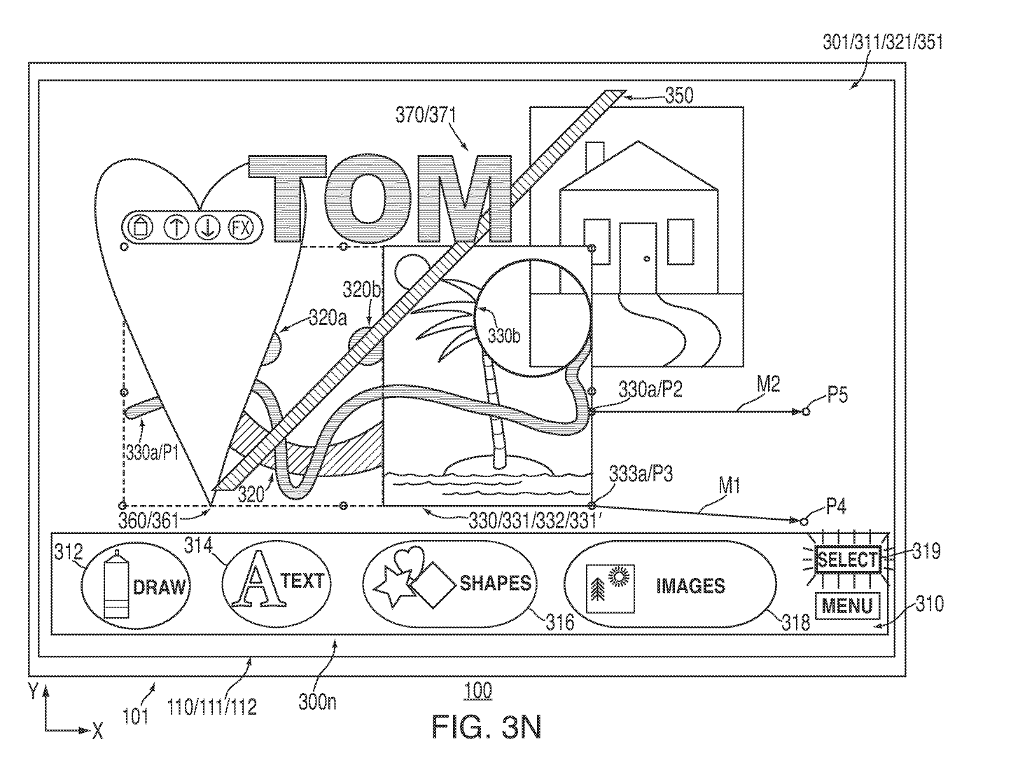

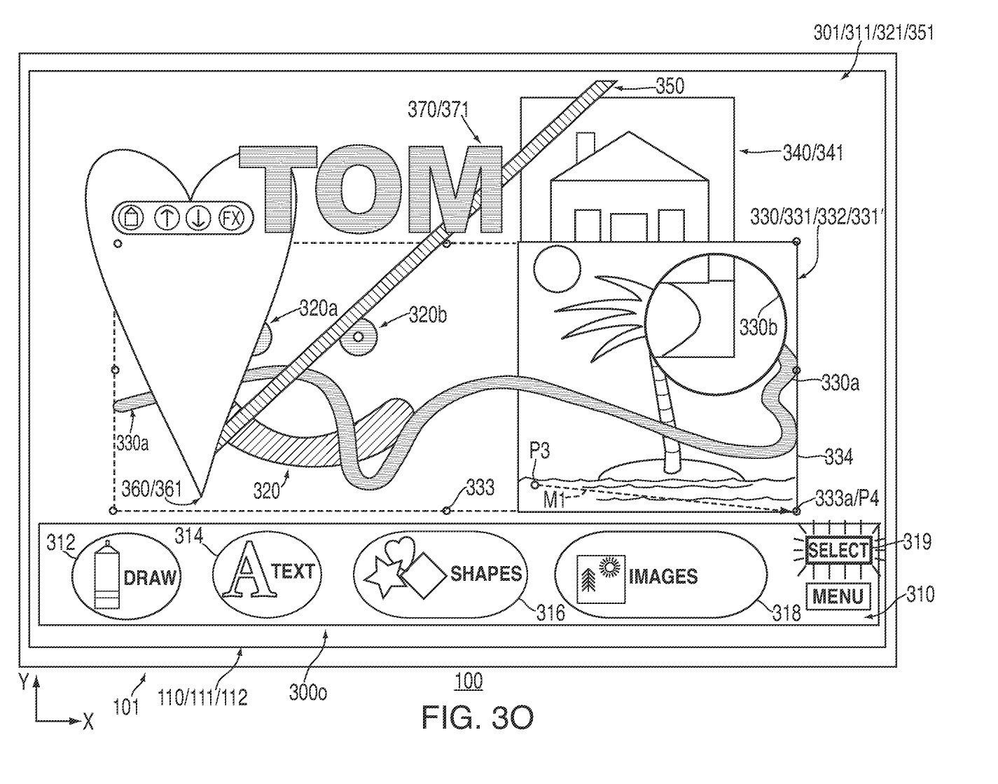

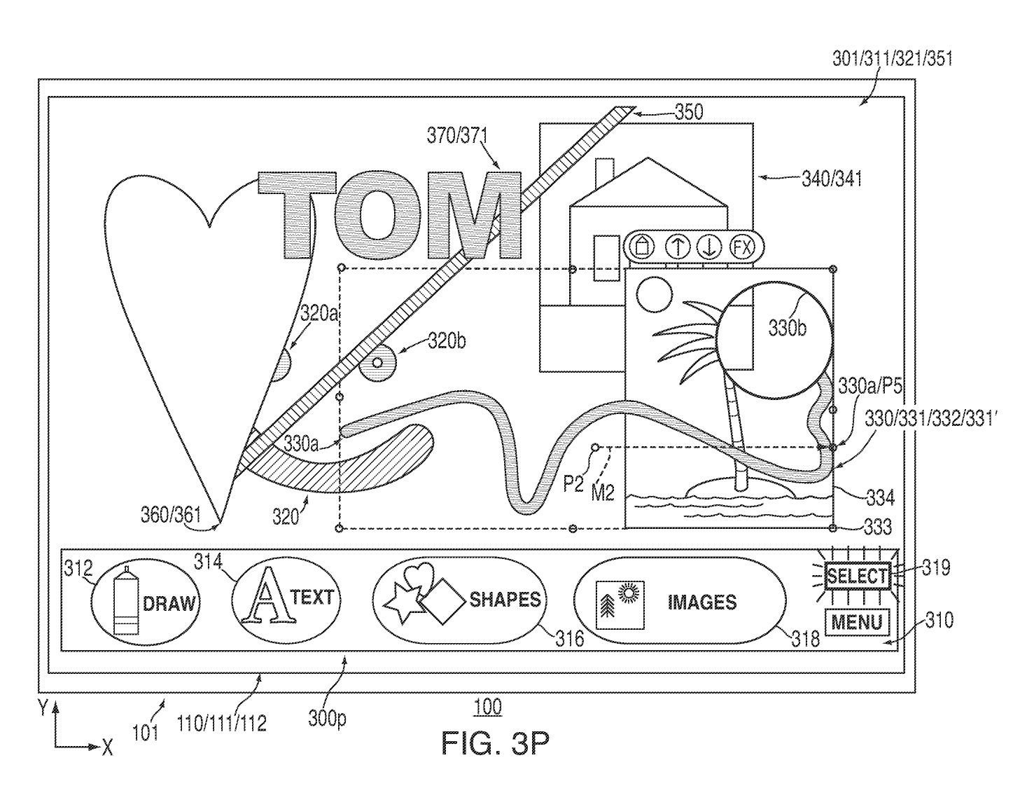

An illustrative example of how graphical display system 201 may generate and display layered graphical object content to a user may be described with reference to FIGS. 3A-3P.

FIGS. 3A-3P, for example, show electronic device 100 with housing 101 and display 112 presenting respective exemplary screens 300a-300p of visual information. As shown, display 112 may be combined with input component 110 to provide an I/O interface component 111, such as a touch screen. At least a portion of the visual information of each one of screens 300a-300p may be generated by graphical object generating module 210 and processed by graphical object processing module 220 of graphical display system 201. As shown, screens 300a-300p may present an interface for a virtual drawing space application of device 100, with which a user may create and manipulate layered graphical objects for making original works of art (e.g., a virtual drawing space application that may be similar to that of Photoshop™ by Adobe Systems Incorporated or Microsoft Paint™ by Microsoft Corporation). It is to be understood, however, that screens 300a-300p are merely exemplary, and display 112 may present any images representing any type of graphical objects and/or graphical object animation that may be generated and processed by graphical display system 201.

For example, as shown in FIGS. 3A-3P, a virtual drawing space application may provide a canvas area 301 on a portion of the screen in which various graphical objects may be presented. Canvas 301 may be a virtual drawing workspace portion of the screen in which pixel data may be created and manipulated for creating user works of art. In some embodiments, canvas 301 may include an initial canvas background layer 311. For example, whenever a virtual drawing space application of device 100 is initially loaded for creating a new layered graphical object document, canvas back ground layer 311 may be automatically defined and generated by layer managing module 208 and then rendered by rendering module 222 as at least a portion of rendered data 223. The size of canvas background layer 311 may be configured to span the entire area of canvas 301. In some embodiments, the size of canvas 301 and, thus, canvas background layer 311, may dynamically change in response to various graphical objects that may be positioned on canvas 301, such that canvas 301 may always be large enough to contain whatever is created on canvas 301. The color of the pixels of canvas back ground layer 311 may all be defined as white (e.g., such that canvas 301 may appear as a blank slate), although any other suitable color or pattern of colors may be used to define the pixels of canvas background layer 311. In some embodiments, layer managing module 208 may be configured to fix canvas back ground layer 311 as the bottom-most layer in any stack of any layers to be utilized by system 201, such that no other layer managed by layer managing module 208 may be re-positioned below canvas background layer 311.

The virtual drawing space application may also provide on a portion of the screen at least one artist menu 310. Menu 310 may include one or more graphical input options that a user may choose from to access various tools and functionalities of the application that may then be utilized by the user to create various types of graphical objects in canvas area 301. Menu 310 may provide one or more toolbars, toolboxes, palettes, buttons, or any other suitable user interface menus that may be one or more layers or windows distinct from canvas 301.

As shown in FIGS. 3A-3P, for example, artist menu 310 may include a free-form drawing stroke or drawing tool input option 312, which a user may select for creating free-form drawing strokes in canvas area 301 (e.g., by repeatedly applying a stamp of a user-controlled virtual input drawing tool along a stroke trail in canvas area 301). Artist menu 310 may also include a text string input option 314, which a user may select for creating strings of characters in canvas area 301. Artist menu 310 may also include a drawing shape input option 316, which a user may select for creating various drawing shapes in canvas area 301. Moreover, artist menu 310 may also include an image input option 318, which a user may select for importing video-based or photographic images into canvas area 301. In some embodiments, artist menu 310 may also include a content selection option 319, which a user may select for identifying a particular portion of displayed content in canvas 301 that the user may wish to manipulate in some way. It is to be understood, however, that options 312-319 of artist menu 310 are merely exemplary, and a virtual drawing space application may provide various other types of options that a user may work with for creating and manipulating content in canvas area 301.

As shown by screen 300a of FIG. 3A, for example, a user may select drawing tool input option 312 of artist menu 310 for creating one or more free-form drawing strokes in canvas area 301. In some embodiments, when a user selects drawing tool input option 312, menu 310 may reveal one or more sub-menus (not shown) that can provide the user with one or more different types of pre-defined drawing stroke input tools or various other drawing stroke properties that may be selected for helping the user define a particular drawing stroke graphical object to be presented in canvas area 301. When drawing tool input option 312 is selected, device 100 may be configured to allow a user to selectively generate one or more drawing strokes in canvas 301 using any suitable sub-menus provided by menu 310 and/or using any other suitable input gestures with any suitable input component 110 available to the user, such as a mouse input component or a touch input component (e.g., touch screen 111).

Once a user has indicated he or she wants to generate a drawing stroke graphical object (e.g., once drawing tool input option 312 has been selected), certain menu selections or other input gestures made by the user may be received by graphical display system 201 for generating and displaying a drawing stroke graphical object in canvas area 301. For example, such menu selections and other input gestures made by the user may be received by graphical object layer managing module 208 of graphical object generating module 210 as drawing stroke graphical object input information 205 for creating a new drawing stroke graphical object.

As mentioned, system 201 may be configured to determine whether to incorporate a new graphical object into a new layer or into a pre-existing layer based on the particular type of the new graphical object and/or based on the particular type of graphical object that may be provided by the current top-most layer provided by system 201. That is, different types of graphical objects may be handled differently by the layer management processes of system 201. For example, in some embodiments, when layer managing module 208 receives graphical object input information 205 that it determines may be used for creating a new drawing stroke graphical object (e.g., once drawing tool input option 312 has been selected, as shown in FIG. 3A), layer managing module 208 may be configured to then determine whether the current top-most layer in any stack of layers is a drawing stroke graphical object layer. Unless the current top-most layer is a drawing stroke layer (e.g., unless the current top-most layer was initially created for a drawing stroke graphical object), layer managing module 208 may also be configured to create any new drawing stroke graphical object in a new layer and then to make that new layer the top-most layer. Therefore, in the current example of FIG. 3A, where the current top-most (and only) layer is a blank canvas background layer 311 having no graphical objects, layer managing module 208 may determine that the current top-most layer is not a drawing stroke layer.

Then, in response to this determination that the current top-most layer is not a drawing stroke layer, and based on the prior determination that input information 205 is currently defining a new drawing stroke graphical object, layer managing module 208 may be configured to define and generate layered graphical object information 209 indicative of a new layer that may be made the top-most layer (e.g., a new top-most layer that may be created by layer managing module 208). Moreover, based on the received graphical object input information 205, layer managing module 208 may also be configured to define and generate this layered graphical object information 209 to be indicative of at least some information that may be used by graphical object defining module 212 to define and generate a new drawing stroke graphical object to be provided in the newly created top-most layer.

Based on this layered graphical object information 209, graphical object defining module 212 may be configured to define and generate at least one new drawing stroke graphical object in the newly created top-most layer defined by layered graphical object information 209. For example, graphical object defining module 212 may generate layered drawing stroke graphical object content 213, which may define not only the drawing stroke graphical object content of the layer indicated by layered graphical object information 209 (e.g., based on one or more drawing stroke graphical object properties initially defined by graphical object input information 205) but also the remaining content of that layer, if any. This layered drawing stroke graphical object content 213 may then be processed by rendering module 222 as rendered layered drawing stroke graphical object data 223 and presented on display 112.

For example, as shown in FIG. 3A, this rendered layered drawing stroke graphical object data may be presented on canvas 301 of screen 300a as a layered drawing stroke graphical object 320 that may be provided on a drawing stroke layer 321. In some embodiments, system 201 may be configured to provide a new drawing stroke layer as a top-most layer that may span the entirety of canvas 301. Moreover, besides the drawing stroke graphical object content provided thereon, a new drawing stroke layer may be provided by system 201 as a transparent drawing stroke layer, such that all graphical object content that was presented by any of the pre-existing layers may still be presented through the new top-most transparent drawing stroke layer (i.e., except for any portions of that pre-existing graphical object content that may be stacked directly underneath the drawing stroke graphical content of the new top-most transparent drawing stroke layer).

As mentioned, when layer managing module 208 receives graphical object input information 205 that it determines may be used for creating a new drawing stroke graphical object (e.g., once drawing tool input option 312 has been selected, as shown in FIG. 3A), layer managing module 208 may be configured to then determine whether the current top-most layer in any stack of layers is a drawing stroke graphical object layer. Moreover, in some embodiments, only if the current top-most layer is a drawing stroke layer, may layer managing module 208 then be configured to create any new drawing stroke graphical object in that pre-existing current top-most layer. For example, continuing with the example of screen 300a of FIG. 3A, once new layered drawing stroke graphical object 320 has been provided on a drawing stroke layer 321 and presented to a user as the top-most layer, and in response to receiving any new graphical object input information 205 that layer managing module 208 may determine is for creating a new drawing stroke graphical object, layer managing module 208 may then be configured to create such a new drawing stroke graphical object in that pre-existing current top-most layer 321.

That is, based on a determination that input information 205 is currently defining a new drawing stroke graphical object, and then in response to a determination that the current top-most layer 321 is a drawing stroke layer, layer managing module 208 may be configured to define and generate new layered graphical object information 209 that may be indicative of the current top-most layer 321. Moreover, based on the new received graphical object input information 205, layer managing module 208 may also be configured to define and generate this new layered graphical object information 209 to be indicative of at least some information that may be used by graphical object defining module 212 to define and generate a new drawing stroke graphical object to be provided in current top-most layer 321.

Based on this new layered graphical object information 209, graphical object defining module 212 may be configured to define and generate at least one new drawing stroke graphical object in the current top-most layer 321 defined by layered graphical object information 209. For example, graphical object defining module 212 may generate new layered drawing stroke graphical object content 213, which may define not only the new drawing stroke graphical object content of the layer indicated by layered graphical object information 209 (e.g., based on one or more new drawing stroke graphical object properties initially defined by the new graphical object input information 205) but also the other content of current top-most layer 321, if any (e.g., pre-existing drawing stroke graphical content 320). This new layered drawing stroke graphical object content 213 may then be processed by rendering module 222 as new rendered layered drawing stroke graphical object data 223 and presented on display 112. For example, as shown in FIG. 3B, this new rendered layered drawing stroke graphical object data may be presented on canvas 301 of screen 300b and may include a new layered drawing stroke graphical object 320a that may be provided on current top-most layer 321 along with pre-existing drawing stroke graphical content 320 that was previously provided on current top-most layer 321.

One or more drawing stroke properties that may have been used by system 201 to define new layered drawing stroke graphical object 320a may be different from one or more drawing stroke properties that may have been used by system 201 to define layered drawing stroke graphical object 320 (e.g., a drawing stroke color property). For example, one or more selections made by a user that may have been provided to system 201 as drawing stroke graphical object input information 205 may have been changed between when system 201 used graphical object input information 205 to define drawing stroke graphical object 320 (e.g., at screen 300a of FIG. 3A) and when system 201 used graphical object input information 205 to define new drawing stroke graphical object 320a (e.g., at screen 300b of FIG. 3B). However, in some embodiments, despite this change in graphical object input information 205, system 201 may be configured to generate and render the two resulting graphical objects on the same layer. For example, because both resulting graphical objects are drawing stroke graphical objects and because no other type of graphical object was created after the first drawing stroke graphical object and before the second drawing stroke graphical object, system 201 may be configured to generate two drawing stroke graphical objects in the same top-most layer. However, in other embodiments, system 201 may be configured to generate two distinct drawing stroke graphical objects on two distinct layers in response to two distinct sets of drawing stroke graphical object input information 205, even if no other graphical object was generated between the two distinct drawing stroke graphical objects.

A similar process may be repeated once graphical object 320a has been added to top-most layer 321. That is, based on a determination that input information 205 is currently defining yet another new drawing stroke graphical object, and then in response to a determination that the current top-most layer is still a drawing stroke layer (e.g., layer 321), layer managing module 208 may be configured to define and generate another new layered graphical object information 209 that may be indicative of the current top-most layer 321. Moreover, based on the new received graphical object input information 205, layer managing module 208 may also be configured to define and generate this new layered graphical object information 209 to be indicative of at least some information that may be used by graphical object defining module 212 to define and generate a new drawing stroke graphical object to be provided in current top-most layer 321.

Based on this new layered drawing stroke graphical object information 209, graphical object defining module 212 may be configured to define and generate at least one new drawing stroke graphical object in the current top-most layer 321 defined by layered graphical object information 209. For example, graphical object defining module 212 may generate new layered drawing stroke graphical object content 213, which may define not only the new drawing stroke graphical object content of the layer indicated by layered graphical object information 209 (e.g., based on one or more new drawing stroke graphical object properties initially defined by the new graphical object input information 205) but also the other content of current top-most layer 321, if any (e.g., pre-existing drawing stroke graphical content 320 and pre-existing drawing stroke graphical content 320a). This new layered drawing stroke graphical object content 213 may then be processed by rendering module 222 as new rendered layered drawing stroke graphical object data 223 and presented on display 112. For example, as shown in FIG. 3C, this new rendered layered drawing stroke graphical object data may be presented on canvas 301 of screen 300c and may include a new layered drawing stroke graphical object 320b that may be provided on current top-most layer 321 along with pre-existing drawing stroke graphical content 320 and pre-existing drawing stroke graphical content 320a that were each previously provided on current top-most layer 321.

At some point, system 201 may receive new graphical object input information that may be indicative of another type of graphical object (i.e., a graphical object type other than a drawing stroke graphical object). For example, as shown by screen 300d of FIG. 3D, a user may select image input option 318 of artist menu 310 for creating one or more image graphical objects in canvas area 301. In some embodiments, when a user selects image input option 318, menu 310 may reveal one or more sub-menus (not shown) that can provide the user with one or more ways in which a user can identify a particular image file of image content to be added to canvas 301. When image input option 318 is selected, device 100 may be configured to allow a user to selectively generate an image graphical object in canvas 301 using any suitable sub-menus provided by menu 310 and/or using any other suitable input gestures with any suitable input component 110 available to the user, such as a mouse input component or a touch input component (e.g., touch screen 111).

Once a user has indicated he or she wants to generate an image graphical object (e.g., once image input option 318 has been selected), certain menu selections or other input gestures made by the user may be received by graphical display system 201 for generating and displaying an image graphical object in canvas area 301. For example, such menu selections and other input gestures made by the user may be received by graphical object layer managing module 208 of graphical object generating module 210 as image graphical object input information 205 for creating a new image graphical object.

As mentioned, system 201 may be configured to determine whether to incorporate a new graphical object into a new layer or into a pre-existing layer based on the particular type of the new graphical object and/or based on the particular type of graphical object that may be provided by the current top-most layer provided by system 201. That is, different types of graphical objects may be handled differently by the layer management processes of system 201. For example, in some embodiments, system 201 may be configured to create any new non-drawing stroke graphical object in a new layer and then to make that new layer the top-most layer in the layer stack. Therefore, in some embodiments, when layer managing module 208 receives graphical object input information 205 that it determines may be used for creating a new image graphical object (e.g., once image input option 318 has been selected, as shown in FIG. 3D), layer managing module 208 may be configured to create such a new image graphical object in a new layer and to make that new layer the top-most layer in the layer stack, regardless of what graphical object type the current top-most layer might be.

Then, based on the determination that input information 205 is currently defining a new image graphical object, and indifferent to the type of the current top-most layer, layer managing module 208 may be configured to define and generate new layered image graphical object information 209 indicative of a new layer that may be made the top-most layer (e.g., a new top-most layer that may be created by layer managing module 208). Moreover, based on the received graphical object input information 205, layer managing module 208 may also be configured to define and generate this layered image graphical object information 209 to be indicative of at least some information that may be used by graphical object defining module 212 to define and generate a new image graphical object to be provided in the newly created top-most layer.

Based on this layered image graphical object information 209, graphical object defining module 212 may be configured to define and generate at least one new image graphical object in the newly created top-most layer defined by layered graphical object information 209. For example, graphical object defining module 212 may generate layered image graphical object content 213, which may define not only the image graphical object content of the layer indicated by layered image graphical object information 209 (e.g., based on one or more image graphical object properties initially defined by image graphical object input information 205) but also the remaining content of that layer, if any. This layered image graphical object content 213 may then be processed by rendering module 222 as rendered layered image graphical object data 223 and presented on display 112.

For example, as shown in FIG. 3D, this rendered layered image graphical object data may be presented on canvas 301 of screen 300d as a layered image graphical object 330 that may be provided on a new image layer 331. In some embodiments, system 201 may be configured to provide new image layer 331 as a top-most layer that may span only the area of the new image graphical object 330 (e.g., as shown in FIG. 3D). Alternatively, system 201 may be configured to provide a new image layer that may span an area greater than that of the new image graphical object (e.g., up to an area spanning the entirety of canvas 301, such as drawing stroke layer 321 of FIG. 3A). In such embodiments where a new image layer may span an area greater than that of the new image graphical object content provided thereon, a new image layer may be provided by system 201 as a transparent image layer, such that all graphical object content that was presented by any of the pre-existing layers may still be presented through the new top-most transparent image layer (i.e., except for any portions of that pre-existing graphical object content that may be stacked directly underneath the image graphical content of the new top-most transparent image layer).

As mentioned, in some embodiments, system 201 may be configured to automatically or optionally provide certain types of graphical object layers with certain layer tools, while other types of graphical object layers may not be provided with those tools. For example, each image graphical object layer may be provided with one or more tools. As shown in FIG. 3D, for example, when new image layer 331 is initially presented on screen 300d, image layer 331 may be presented along with one or more tools 332. Various types of tools may be provided for such a new image layer based on various situations or user preferences. For example, as shown, image layer tools 332 may include one or more control points 333 that may be positioned along the boundary 334 of image layer 331 or at any other suitable position or positions associated with image graphical object 330 or its layer 331. In some embodiments, one control point 333 may be positioned at each corner of boundary 334 and one control point 333 may be positioned along each edge of boundary 334 between two corners. One or more of these control points 333 may be manipulated for stretching, shrinking, and/or moving image layer 331 and its image graphical object 330 in various ways along canvas 301 (e.g., as described with respect to FIGS. 3N-3P).

As another example, image layer tools 332 may include a menu or toolbar 335 that may allow a user to manipulate image layer 331 in various other ways. For example, toolbar 335 may include a toolbar option 336 that a user may interact with for applying a new graphical object into image layer 331 (e.g., as described with respect to FIGS. 3J and 3K). Additionally or alternatively, toolbar 335 may include a toolbar option 337 that a user may interact with for moving image layer 331 up in the stack of layers (e.g., as described with respect to FIG. 3I). Similarly, toolbar 335 may additionally or alternatively include a toolbar option 338 that a user may interact with for moving image layer 331 down in the stack of layers (e.g., as described with respect to FIG. 3H). As yet another example, toolbar 335 may additionally or alternatively include a toolbar option 339 that a user may interact with for applying various effects or performing other suitable operations on image layer 331.

As also shown in FIG. 3D, for example, content selection option 319 of menu 310 may be activated. While in some embodiments a user may actively select or interact with content selection option 319 (e.g., to communicate to system 201 that the user is going to actively identify a portion of a displayed graphical object layer that he or she wishes to manipulate), content selection option 319 may sometimes be passively activated by system 201 to indicate to a user that a particular graphical object layer is currently selected and activated for manipulation. For example, this may occur when one or more tools for certain types of layered graphical objects are first generated on canvas 301. That is, in some embodiments, system 201 may be configured to activate content selection option 319 of menu 310 when system 201 presents tools 332 for image layer 331 (e.g., as shown in screen 300d of FIG. 3D).

Rather than interacting with any of image layer tools 332 of image layer 331 of screen 300d of FIG. 3D, a user may instead choose to create another graphical object on canvas 301. For example, as shown by screen 300e of FIG. 3E, a user may once again select image input option 318 of artist menu 310 for creating another image graphical object in canvas area 301. As with image graphical object 330, system 201 may be configured to create any new non-drawing stroke graphical object in a new layer and then to make that new layer the top-most layer in the layer stack. Therefore, in some embodiments, when layer managing module 208 receives graphical object input information 205 that it determines may be used for creating a new image graphical object (e.g., once image input option 318 has been selected, as shown in FIG. 3E), layer managing module 208 may be configured to create such a new image graphical object in a new layer and to make that new layer the top-most layer in the layer stack, regardless of what graphical object type the current top-most layer might be. For example, layer managing module 208 may be configured to define and generate new layered image graphical object information 209 indicative of a new layer that may be made the top-most layer (e.g., a new top-most layer that may be created by layer managing module 208). Moreover, based on the received graphical object input information 205, layer managing module 208 may also be configured to define and generate this layered image graphical object information 209 to be indicative of at least some information that may be used by graphical object defining module 212 to define and generate a new image graphical object to be provided in the newly created top-most layer.

Based on this layered image graphical object information 209, graphical object defining module 212 may be configured to define and generate at least one new image graphical object in the newly created top-most layer defined by layered graphical object information 209. For example, graphical object defining module 212 may generate layered image graphical object content 213, which may define not only the image graphical object content of the layer indicated by layered image graphical object information 209 (e.g., based on one or more image graphical object properties initially defined by image graphical object input information 205) but also the remaining content of that layer, if any. This layered image graphical object content 213 may then be processed by rendering module 222 as rendered layered image graphical object data 223 and presented on display 112.

For example, as shown in FIG. 3E, this rendered layered image graphical object data may be presented on canvas 301 of screen 300e as a new layered image graphical object 340 that may be provided on a new image layer 341. As with previous image layer 331, system 201 may be configured to provide new image layer 341 as a top-most layer that may span only the area of the new image graphical object 340 (e.g., as shown in FIG. 3E). Alternatively, system 201 may be configured to provide a new image layer that may span an area greater than that of the new image graphical object. Also, as with previous image layer 331, system 201 may be configured to automatically or optionally provide new image layer 341 with one or more tools 342. Image layer tools 342 may be similar to tools 341 provided by image layer 331 and may include one or more control points 343 along a layer boundary 344, as well as a menu or toolbar 345 that may include toolbar options 346-349. In some embodiments, system 201 may be configured to automatically provide the same set of tools for every new image layer generated on canvas 301. This may provide a user with a simple and predictable interface.

As also shown in FIG. 3E, for example, content selection option 319 of menu 310 may be activated. As mentioned, content selection option 319 may sometimes be passively activated by system 201 to indicate to a user that a particular graphical object layer is currently selected and activated for manipulation. That is, in some embodiments, system 201 may be configured to activate content selection option 319 of menu 310 when system 201 presents tools 342 for image layer 341. Moreover, when a new graphical object layer is initially presented, or when any particular graphical object layer is currently selected and activated for manipulation, system 201 may be configured to remove all previously displayed tools for any other graphical object layers. For example, as shown in FIG. 3E, when new image layer 341 is initially presented on screen 300e, any tools that were previously presented (e.g., tools 332 of screen 300d of FIG. 3D) may be removed. By only presenting layer tools for a single layer (e.g., the currently activated layer) at a particular time, system 201 may be less likely to confuse a user. This may provide a more user-friendly interface for managing multiple graphical object layers. In some embodiments, when a particular layer is selectively activated, system 201 may be configured to highlight that layer in one or more ways that are distinct from any tools that may be associated with that layer. For example, system 201 may provide a blinking effect to a boundary of a selectively activated layer that may help a user identify the currently activated layer. Any suitable interface effect may be utilized by system 201 to distinguish the activated layer.

Rather than interacting with any of image layer tools 342 of image layer 341 of screen 300e of FIG. 3E, a user may instead choose to create another graphical object on canvas 301. For example, as shown by screen 300f of FIG. 3F, a user may once again select drawing tool input option 312 of artist menu 310 for creating another drawing stroke in canvas area 301. As mentioned, system 201 may be configured to determine whether to incorporate a new graphical object into a new layer or into a pre-existing layer based on the particular type of the new graphical object and/or based on the particular type of graphical object that may be provided by the current top-most layer provided by system 201. For example, in some embodiments, when layer managing module 208 receives graphical object input information 205 that it determines may be used for creating a new drawing stroke graphical object (e.g., once drawing tool input option 312 has been selected, as shown in FIG. 3F), layer managing module 208 may be configured to then determine whether the current top-most layer is a drawing stroke graphical object layer. Unless the current top-most layer is a drawing stroke layer (e.g., unless the current top-most layer was initially created for a drawing stroke graphical object), layer managing module 208 may also be configured to create any new drawing stroke graphical object in a new layer and then to make that new layer the top-most layer. Therefore, in the current example of FIG. 3F, where the top-most layer prior to creating any new drawing stroke in a new layer is image layer 341, layer managing module 208 may determine that the current top-most layer is not a drawing stroke layer.

Then, in response to this determination that the current top-most layer is not a drawing stroke layer, and based on the prior determination that input information 205 is currently defining a new drawing stroke graphical object, layer managing module 208 may be configured to define and generate layered graphical object information 209 indicative of a new layer that may be made the top-most layer (e.g., a new top-most layer that may be created by layer managing module 208 on top of current top-most layer 341). Moreover, based on the received graphical object input information 205, layer managing module 208 may also be configured to define and generate this layered graphical object information 209 to be indicative of at least some information that may be used by graphical object defining module 212 to define and generate a new drawing stroke graphical object to be provided in the newly created top-most layer.

Based on this layered graphical object information 209, graphical object defining module 212 may be configured to define and generate at least one new drawing stroke graphical object in the newly created top-most layer defined by layered graphical object information 209. For example, graphical object defining module 212 may generate layered drawing stroke graphical object content 213, which may define not only the drawing stroke graphical object content of the layer indicated by layered graphical object information 209 (e.g., based on one or more drawing stroke graphical object properties initially defined by graphical object input information 205) but also the remaining content of that layer, if any. This layered drawing stroke graphical object content 213 may then be processed by rendering module 222 as rendered layered drawing stroke graphical object data 223 and presented on display 112.

For example, as shown in FIG. 3F, this rendered layered drawing stroke graphical object data may be presented on canvas 301 of screen 300f as a layered drawing stroke graphical object 350 that may be provided on a new drawing stroke layer 351, and system 201 may provide new drawing stroke layer 351 as the top-most layer in the stack. In some embodiments, system 201 may be configured to provide new drawing stroke layer 351 as a top-most layer that may span the entirety of canvas 301. Moreover, besides drawing stroke graphical object content 350 provided thereon, new drawing stroke layer 351 may be provided by system 201 as a transparent drawing stroke layer, such that all graphical object content that was presented by any of the pre-existing layers may still be presented through new top-most transparent drawing stroke layer 351 (i.e., except for any portions of that pre-existing graphical object content that may be stacked directly underneath drawing stroke graphical object content 350 of new top-most transparent drawing stroke layer 351, as shown in FIG. 3F).

As also shown in FIG. 3F, for example, content selection option 319 of menu 310 may not be activated. As mentioned, content selection option 319 may sometimes be passively activated by system 201 to indicate to a user that a particular graphical object layer is currently selected and activated for manipulation. However, in some embodiments, system 201 may be configured such that a user may not manipulate a drawing stroke graphical object in certain ways once it is generated on canvas 301. For example, system 201 may be configured such that a drawing stroke graphical object may not be moved to a different portion of canvas 301. Additionally or alternatively, system 201 may be configured such that a drawing stroke graphical object layer may not be actively moved up or down in the stack. Therefore, in such embodiments, layer tools may not be provided for drawing stroke layer 351 and content selection option 319 may not be activated. By not allowing a user to manipulate a drawing stroke layer in some of the same ways a user may manipulate an image layer, for example, system 201 may provide a user with a simpler and less confusing interface for creating and managing multiple graphical object layers. However, as mentioned with respect to FIG. 3E, when a new graphical object layer is initially presented, system 201 may be configured to remove all previously displayed tools for any other graphical object layers. For example, as shown in FIG. 3F, when new drawing stroke layer 351 is initially presented on screen 300f, any tools that were previously presented (e.g., tools 342 of screen 300e of FIG. 3E) may be removed.

Although system 201 may be configured not to provide a drawing stroke graphical object layer with certain layer tools, such that a user may not manage a drawing stroke layer in some of the ways a user may manage another graphical object layer, a user may still be able to edit a drawing stroke layer in certain other ways. For example, when a drawing stroke layer is the current top-most layer, system 201 may be configured to allow a user to add additional drawing stroke graphical objects to that layer (e.g., as described with respect to FIGS. 3B and 3C). Similarly, when a drawing stroke layer is the current top-most layer, system 201 may be configured to allow a user to remove at least portions of certain drawing stroke graphical objects from that layer or, in some embodiments, from any layer (e.g., using an eraser-type drawing tool). For example, as shown in FIG. 3F, when drawing stroke layer 351 is the current top-most layer, system 201 may be configured to allow a user to remove any portion of drawing stroke graphical object content 350 from layer 351 as well as any currently visible portion of any other drawing stroke graphical object content, such as all of drawing stroke graphical object content 320a and the portions of drawing stroke graphical object content 320 not covered by intervening layer 331 (e.g., using an eraser-type drawing tool).

Rather than editing top-most drawing stroke layer 351 of screen 300f of FIG. 3F, a user may instead choose to selectively activate another graphical object layer of canvas 301. For example, as shown by screen 300g of FIG. 3G, a user may selectively activate content selection option 319 of menu 310. Such an active selection of selection option 319 may communicate to system 201 that the user wishes to actively identify a portion of a displayed graphical object layer for manipulation. Therefore, when content selection option 319 is activated, system 201 may be configured to receive selection input information to determine which graphical object layer is to be selected for manipulation (e.g., image layer 331 of FIG. 3G).

As shown in FIG. 2, system 201 may include a selection detecting module 230, which may determine the status of a user's interaction with one or more positions on canvas 301. For example, a user input component 110 may provide selection detecting module 230 with selection input information 207 that may be indicative of a particular type of user interaction with a displayed graphical object or any other portion of a displayed graphical object layer. A user may point to or otherwise attempt to identify a particular distinct portion of a displayed graphical object on display 112 using any suitable input component 110, such as a mouse or touch screen, and may then submit one or more particular input commands for generating selection input information 207 with respect to the particular distinct portion of the displayed graphical object. For example, a user may click a mouse input component or tap a touch screen input component at a particular displayed portion of a particular graphical object or any other portion of a particular graphical object layer. It is to be understood that any suitable input component may be used to point to or otherwise identify a particular portion of a displayed graphical object or layer and that any suitable input gesture of that input component may be used to interact with that particular portion in any particular way.

Once suitable selection input information 207 is provided by input component 110, selection detecting module 230 may compare that selection input information 207 with known position information of particular graphical objects and layers on canvas 301. For example, as described above, bounding area information 227 generated by bounding module 224 of graphical object processing module 220 may be compared with user input information indicative of a user interaction with one or more displayed graphical objects, and such a comparison may help determine with which particular graphical object the user is intending to interact. Therefore, in some embodiments, selection detecting module 230 may compare user selection input information 207 with bounding area information 227 to determine which displayed graphical object layer the user is intending to interact with.

Based on this determination, selection detecting module 230 may generate selection determination information 237. This selection determination information 237 may be indicative of a user-selected graphical object layer. For example, selection determination information 237 may define which graphical object layer on canvas 301 is to be activated for manipulation and/or editing. Layer managing module 208 may receive this selection determination information 237 and may activate the particular layer identified by selection determination information 237. For example, layer managing module 208 may be configured to provide layer tools or other visual indicia on canvas 301 to indicate to the user that the particular layer is activated.

As shown in FIG. 3G, for example, a user may select selection 319 of artist menu 310 for identifying and activating a particular graphical object layer in canvas area 301. Once a user has indicated he or she wants to activate an existing graphical object layer (e.g., once selection input option 319 has been selected), certain input gestures made by the user may be received by graphical display system 201 for determining which layer is to be activated (e.g., as selection input information 207). For example, in order to activate image layer 331 of image graphical object 330, a user may provide an input gesture at a position on canvas 301 where a portion of layer 331 is visible. As shown in FIG. 3G, because both layers 341 and 351 are currently on top of layer 331, such a visible portion of layer 331 may be any portion of image graphical object 330 that is not covered by image graphical object 340 of layer 341 and that is not covered by drawing stroke graphical object 350 of layer 351.

Once a user provides suitable selection input information 207 for identifying image layer 331, system 201 may be configured to activate that layer, such that a user may edit or manipulate that layer in one or more ways. For example, when a particular existing graphical object layer is selected, system 201 may be configured to visually distinguish that layer in one or more suitable ways. In some embodiments, system 201 may be configured to highlight the activated layer as compared to the non-activated layers, or shadow, dim, or otherwise make less distinct the non-activated layers as compared to the activated layers on the display. In some embodiments, system 201 may be configured to display any appropriate layer tools for the activated layer. In some embodiments, system 201 may be configured to remove all other previously displayed tools. As shown in FIG. 3G, once image layer 331 has been selected, one or more layer tools 332 of layer 331 may be presented to the user and any other tools that may have been previously displayed for another layer may be removed. In some embodiments, when a selected layer is not the current top-most layer, system 201 may be configured to display any visually distinguishing elements, such as layer tools for that selected layer, on canvas 301 in a temporary new layer that may be provided as the top-most layer such that the distinguishing elements may be visible on canvas 301. For example, as shown in FIG. 3G, when image layer 331 is selected, system 201 may determine that layer 331 is not the current top-most layer (e.g., drawing stroke layer 351 may be the current top-most layer), and system 201 may then provide any layer tool 332 for selected image layer 331 in a temporary new tool layer 331′ that may be made the top-most layer. Therefore, despite portions of image 330 of selected image layer 331 being covered by portions of higher-up layers (e.g., portions of image 340 of layer 341 and portions of drawing stroke 350 of layer 351), tools 332 of new tool layer 331′ may be provided on top of those higher-up layers, as shown in FIG. 3G. In other embodiments, system 201 may be configured to position certain layer tools for a selected graphical object layer on a portion of screen 301 that does not include higher-up layer content that would otherwise cover the tools.

Once a particular graphical object layer has been selectively activated and any appropriate layer tools or other visual distinctions have been presented, system 201 may be configured to allow a user to interact with the layer for editing or manipulating the layer in one or more ways. A user may interact with layer tools in any suitable way, such as via an input component 110. For example, once a particular graphical object layer has been selected, system 201 may be configured to receive selection input information 207 indicative of a particular user interaction with a particular layer tool of that selected layer. Based on this information, system 201 may be configured to re-render the contents of canvas 301 in accordance with the associated function of the selected layer tool.

For example, as shown in screen 300h of FIG. 3H, a user may interact with toolbar option 338 of layer toolbar 335 of layer tools 332 for moving selected image layer 331 down in the stack of layers, such that image layer 331 may now be positioned below drawing stroke layer 321. Alternatively, as shown in screen 300i of FIG. 3I, for example, a user may interact with toolbar option 337 of layer toolbar 335 of layer tools 332 for moving selected image layer 331 up in the stack of layers, such that image layer 331 may now be positioned above image layer 341. All of the contents of a selected layer may be moved up or down in the stack of layers along with the selected layer. For example, all image graphical object content 330 of image layer 331 may move in the stack along with layer 331. In some embodiments, a user may interact with a layer tool to move a layer along a stack one layer at a time (e.g., to move a layer above an immediately higher-up layer or below an immediately lower-down layer). Additionally or alternatively, a user may interact with a layer tool to move a layer along a stack by more than one layer at a time (e.g., to move a layer immediately all the way to the top of the stack or to move a layer immediately all the way to the bottom of a stack).

In some embodiments, an image graphical object layer may be provided with a layer tool for actively moving the image layer up or down in the stack of layers, while a drawing stroke graphical object layer may not be provided with such a layer tool for actively moving the drawing stroke layer up or down in the stack. However, it is to be understood, that even in such embodiments, the position of a drawing stroke layer in a stack may be changed. For example, by actively moving image layer 331 down in the stack from FIG. 3G to FIG. 3H, drawing stroke layer 321 may have been moved up in the stack (e.g., above image layer 331). Moreover, in some embodiments, two distinct drawing stroke layers may be merged into a single drawing stroke layer. For example, if every content layer existing between two distinct drawing stroke layers is deleted, the two distinct drawing stroke layers may be merged into a single drawing stroke layer, which may save memory resources of the system. As a particular example, if image layer 331 and all of its image graphical object content 330 is deleted or otherwise removed from canvas 301, and if image layer 341 and all of its image graphical object content 340 is similarly deleted or otherwise removed from canvas 301, then drawing stroke layer 351 of drawing stroke 350 may be directly above drawing stroke layer 321 of drawing strokes 320, 320a, and 320b. In such an embodiment, drawing stroke layers 351 and 321 may merge into a single drawing stroke layer on canvas 301.

Continuing with the example of FIG. 3I, in which selected image layer 331 may have been moved up in the stack of layers, such that image layer 331 may now be positioned above image layer 341, a user may utilize another layer tool 332 of selected image layer 331. For example, as shown in FIG. 3J, a user may interact with toolbar option 336 of toolbar 335 for applying a new graphical object into selected image layer 331. In some embodiments, system 201 may be configured to allow a user to create a drawing stroke graphical object in image layer 331. As shown in FIG. 3J, when a user selects toolbar option 336, system 201 may select drawing stroke input tool 312 of menu 310, which may indicate to a user that one or more drawing stroke graphical objects may now be created in selected image layer 331. Of course, in other embodiments, system 201 may not update menu 310 to indicate that selected image layer 331 is now configured to receive a drawing stroke graphical object. In some embodiments, menu 310 may not be provided at all.

Once system 201 is configured to allow a new drawing stroke graphical object to be created in selected image layer 331, a user may interact with device 100 in any suitable way to define such a drawing stroke graphical object (e.g., as described with respect to drawing stroke graphical object 320 and/or 350). Any drawing stroke graphical object content provided in layer 331 may be provided at the same position in layer 331 as image content 330. For example, as shown in FIG. 3J, a drawing stroke graphical object 330a may be generated and presented in image layer 331 within original boundary 334 of layer 331, and thus in a portion of image layer 331 that originally included a portion of image content 330. In some embodiments, system 201 may be configured to replace any previously generated graphical object content of a layer with new graphical object content of that layer. For example, some pixel data of image layer 331 that had been representative of image content 330 may be redefined as pixel data representative of new drawing stroke content 330a of layer 330.

In some embodiments, the original boundary 334 of image layer 331 may limit the area in which new graphical object content may be added. For example, as shown in FIG. 3J, right-side boundary 334r of boundary 334 of image layer 331 may be fixed on canvas 301 such that new drawing stroke graphical object 330a may not extend past right-side boundary 334r. Alternatively, in other embodiments, the original boundary 334 of image layer 331 may dynamically change as new graphical object content is added to layer 331. For example, as shown in FIG. 3J, left-side boundary 334l of original boundary 334 of image layer 331 may not be fixed on canvas 301 such that new drawing stroke graphical object 330a may extend past left-side boundary 334l in the direction of arrow L. In such embodiments where the original boundary of a selected graphical object layer may dynamically change as new graphical object content is added to the layer, additional content may be added to the layer besides the additional new graphical object content. For example, as shown in FIG. 3J, when new drawing stroke graphical content 330a is added to image layer 331 beyond original boundary 334l, boundary 334 of image layer 331 may expand to include new left-side boundary 334l′. Therefore, when image layer 331 is configured to be a translucent layer, all the content of image layer 331 between original left-side boundary 334l and new left-side boundary 334l′ may be defined as additional translucent content of image layer 331, except for the portion of drawing stroke graphical object content 330a that may be defined between original left-side boundary 334l and new left-side boundary 334l′. Although not shown in FIG. 3J, toolbar 335 may move with left-side boundary 334l′ so that toolbar 335 may remain at the upper-left corner of layer 331 (see, e.g., FIG. 3N). It is to be noted that any new graphical object content added to an existing graphical object layer may be contained by that layer within the layer stack. For example, as shown in FIG. 3J, all of new drawing stroke 330a of image layer 331 may be positioned above layer 321 and its drawing stroke content 320, and below layer 351 and its drawing stroke content 350, just like the other content of image layer 331.

As mentioned, drawing stroke graphical object content may be defined by any suitable drawing stroke input tool properties. For example, rather than being defined by opaque and/or colored properties, a drawing stroke graphical object may be defined by translucent properties, which may be used to configure a drawing stroke input tool as an eraser. As shown in screen 300k of FIG. 3K, for example, when a user selects toolbar option 336 of layer tools 332 of selected image layer 331, and then generates appropriate drawing stroke input information 205 indicative of an eraser drawing stroke property, system 201 may be configured to generate and present a new drawing stroke graphical object 330b in selected image layer 331. Unlike new drawing stroke graphical object content 330a, which may be defined by particular opaque color drawing stroke properties for re-defining certain content of layer 331 as that opaque color, new drawing stroke graphical object content 330b may be defined as a translucent eraser drawing stroke that may re-define certain content of layer 331 as translucent. By re-defining certain content of image layer 331 as translucent, any layered graphical object content of one or more layers positioned below image layer 331 in the stack may be visible on canvas 301. For example, as shown in screen 300k of FIG. 3K, a new translucent or eraser drawing stroke 330b generated in image layer 331 may expose a portion of image 340 of image layer 341, even though image layer 341 may be positioned below image layer 331 in the layer stack. In some embodiments, once layered graphical object content of one or more layers positioned below image layer 331 in the stack becomes visible on canvas 301 due to the re-defining of certain content of image layer 331 as translucent, the now visible portion of the one or more lower layers may be likewise re-defined as translucent. For example, the application may be configured such that any content of a lower layer made visible due to re-defining a higher layer as translucent may be similarly re-defined through additional drawing strokes at that content without requiring the user to activate the layer containing that now visible content. In other embodiments, the application may require that the user selectively activate the layer containing the now visible content before that now visible content may be similarly re-defined as translucent.

In some embodiments, any new type of graphical object content may be added to any type of existing layer. For example, rather than generating new drawing stroke content in selected image layer 331, a user may instead add an additional image graphical object to image layer 331 (e.g., either adjacent original image 330 in layer 331 or at least partially over original image 330, which may re-define certain content of image layer 331). Moreover, in addition to or instead of providing a user with the ability to move a selected layer within a stack and the ability to generate additional new graphical object content within a selected layer, system 201 may be configured to provide a user with the ability to edit the graphical object content of a selected layer in any other suitable way. For example, when a user selects toolbar option 339 of layer tools 332 of selected image layer 331, system 201 may be configured to allow image content 330 and/or any other portion of image layer 331 to be edited in any suitable way, including, but not limited to, cropping or rotating image 330, shading or otherwise changing an image property or effect of image 330, and the like.

Rather than interacting any further with image layer 331 of screen 300k of FIG. 3K, a user may instead choose to create another graphical object on canvas 301. For example, as shown by screen 300l of FIG. 3L, a user may select drawing shape input option 316 of artist menu 310 for creating a drawing shape graphical object in canvas area 301. In some embodiments, when a user selects drawing shape input option 316, menu 310 may reveal one or more sub-menus (not shown) that can provide the user with one or more ways in which a user can identify a particular shape to be added to canvas 301. When drawing shape input option 316 is selected, device 100 may be configured to allow a user to selectively generate a drawing shape graphical object in canvas 301 using any suitable sub-menus provided by menu 310 and/or using any other suitable input gestures with any suitable input component 110 available to the user, such as a mouse input component or a touch input component (e.g., touch screen 111).

Once a user has indicated he or she wants to generate a drawing shape graphical object (e.g., once drawing shape input option 316 has been selected), certain menu selections or other input gestures made by the user may be received by graphical display system 201 for generating and displaying a drawing shape graphical object in canvas area 301. For example, such menu selections and other input gestures made by the user may be received by graphical object layer managing module 208 of graphical object generating module 210 as drawing shape graphical object input information 205 for creating a new drawing shape graphical object.

As mentioned, system 201 may be configured to determine whether to incorporate a new graphical object into a new layer or into a pre-existing layer based on the particular type of the new graphical object and/or based on the particular type of graphical object that may be provided by the current top-most layer provided by system 201. That is, different types of graphical objects may be handled differently by the layer management processes of system 201. For example, in some embodiments, system 201 may be configured to create any new non-drawing stroke graphical object in a new layer and then to make that new layer the top-most layer in the layer stack. Therefore, in some embodiments, when layer managing module 208 receives graphical object input information 205 that it determines may be used for creating a new drawing shape graphical object (e.g., once drawing shape input option 316 has been selected, as shown in FIG. 3L), layer managing module 208 may be configured to create such a new drawing shape graphical object in a new layer and to make that new layer the top-most layer in the layer stack, regardless of what graphical object type the current top-most layer might be. It should be noted that in the current example, the current top-most layer may have been determined to be drawing stroke layer 351 of drawing stroke 350, despite the fact that image layer 331 may have been selected for manipulation, and despite the fact that a temporary tools layer 331′ may have been generated for presenting layer tools 332 of selected layer 331. Therefore, system 201 may be configured to determine the current top-most layer to be a layer other than a currently selected layer and other than a temporary tool layer.

Continuing with the example of FIG. 3L, based on the determination that input information 205 is currently defining a new drawing shape graphical object, and indifferent to the type of the current top-most layer, layer managing module 208 may be configured to define and generate new layered drawing shape graphical object information 209 indicative of a new layer that may be made the top-most layer (e.g., a new top-most layer that may be created by layer managing module 208). Moreover, based on the received graphical object input information 205, layer managing module 208 may also be configured to define and generate this layered drawing shape graphical object information 209 to be indicative of at least some information that may be used by graphical object defining module 212 to define and generate a new drawing shape graphical object to be provided in the newly created top-most layer.

Based on this layered drawing shape graphical object information 209, graphical object defining module 212 may be configured to define and generate at least one new drawing shape graphical object in the newly created top-most layer defined by layered graphical object information 209. For example, graphical object defining module 212 may generate layered drawing shape graphical object content 213, which may define not only the drawing shape graphical object content of the layer indicated by layered drawing shape graphical object information 209 (e.g., based on one or more drawing shape graphical object properties initially defined by drawing shape graphical object input information 205) but also the remaining content of that layer, if any. This layered drawing shape graphical object content 213 may then be processed by rendering module 222 as rendered layered drawing shape graphical object data 223 and presented on display 112.

For example, as shown in FIG. 3L, this rendered layered drawing shape graphical object data may be presented on canvas 301 of screen 300l as a layered drawing shape graphical object 360 that may be provided on a new image layer 361 (e.g., as a heart-shaped drawing shape graphical object). In some embodiments, system 201 may be configured to provide new drawing shape layer 361 as a top-most layer that may span only the area of the new drawing shape graphical object 360. Alternatively, system 201 may be configured to provide a new drawing shape layer that may span an area greater than that of the new drawing shape graphical object (e.g., up to an area spanning the entirety of canvas 301, such as drawing stroke layer 321 of FIG. 3A). A new drawing shape layer may be provided by system 201 as a transparent drawing shape layer, such that all graphical object content that was presented by any of the pre-existing layers may still be presented through the new top-most transparent drawing shape layer (i.e., except for any portions of that pre-existing graphical object content that may be stacked directly underneath the drawing shape graphical object content of the new top-most transparent drawing shape layer).

As mentioned, in some embodiments, system 201 may be configured to automatically or optionally provide certain types of graphical object layers with certain layer tools, while other types of graphical object layers may not be provided with those tools. For example, each drawing shape graphical object layer may be provided with one or more tools, which may be similar to or different from those provided to image graphical object layers. As shown in FIG. 3L, for example, when new drawing shape layer 361 is initially presented on screen 300l, image layer 361 may be presented along with one or more tools 362.

Rather than interacting with new drawing shape layer 361 of screen 300l of FIG. 3L, a user may instead choose to create another graphical object on canvas 301. For example, as shown by screen 300m of FIG. 3M, a user may select text string input option 314 of artist menu 310 for creating a text string graphical object in canvas area 301. In some embodiments, when a user selects text string input option 314, menu 310 may reveal one or more sub-menus (not shown) that can provide the user with one or more ways in which a user can identify a particular text string to be added to canvas 301. When text string input option 314 is selected, device 100 may be configured to allow a user to selectively generate a text string graphical object in canvas 301 using any suitable sub-menus provided by menu 310 and/or using any other suitable input gestures with any suitable input component 110 available to the user, such as a mouse input component or a touch input component (e.g., touch screen 111).

Once a user has indicated he or she wants to generate a text string graphical object (e.g., once text string input option 314 has been selected), certain menu selections or other input gestures made by the user may be received by graphical display system 201 for generating and displaying a text string graphical object in canvas area 301. For example, such menu selections and other input gestures made by the user may be received by graphical object layer managing module 208 of graphical object generating module 210 as text string graphical object input information 205 for creating a new text string graphical object.

As mentioned, system 201 may be configured to determine whether to incorporate a new graphical object into a new layer or into a pre-existing layer based on the particular type of the new graphical object and/or based on the particular type of graphical object that may be provided by the current top-most layer provided by system 201. That is, different types of graphical objects may be handled differently by the layer management processes of system 201. For example, in some embodiments, system 201 may be configured to create any new non-drawing stroke graphical object in a new layer and then to make that new layer the top-most layer in the layer stack. Therefore, in some embodiments, when layer managing module 208 receives graphical object input information 205 that it determines may be used for creating a new text string graphical object (e.g., once text string input option 314 has been selected, as shown in FIG. 3M), layer managing module 208 may be configured to create such a new text string graphical object in a new layer and to make that new layer the top-most layer in the layer stack, regardless of what graphical object type the current top-most layer might be.

Therefore, based on the determination that input information 205 is currently defining a new text string graphical object, and indifferent to the type of the current top-most layer, layer managing module 208 may be configured to define and generate new layered text string graphical object information 209 indicative of a new layer that may be made the top-most layer (e.g., a new top-most layer that may be created by layer managing module 208). Moreover, based on the received graphical object input information 205, layer managing module 208 may also be configured to define and generate this layered text string graphical object information 209 to be indicative of at least some information that may be used by graphical object defining module 212 to define and generate a new text string graphical object to be provided in the newly created top-most layer.

Based on this layered text string graphical object information 209, graphical object defining module 212 may be configured to define and generate at least one new text string graphical object in the newly created top-most layer defined by layered graphical object information 209. For example, graphical object defining module 212 may generate layered text string graphical object content 213, which may define not only the text string graphical object content of the layer indicated by layered text string graphical object information 209 (e.g., based on one or more text string graphical object properties initially defined by text string graphical object input information 205) but also the remaining content of that layer, if any. This layered text string graphical object content 213 may then be processed by rendering module 222 as rendered layered text string graphical object data 223 and presented on display 112.

For example, as shown in FIG. 3M, this rendered layered text string graphical object data may be presented on canvas 301 of screen 300m as a layered text string graphical object 370 that may be provided on a new text string layer 371 (e.g., as text string character glyphs “TOM”). In some embodiments, system 201 may be configured to provide new text string layer 371 as a top-most layer that may span only the area of the new text string graphical object 370. Alternatively, system 201 may be configured to provide a new text string layer that may span an area greater than that of the new text string graphical object (e.g., up to an area spanning the entirety of canvas 301, such as drawing stroke layer 321 of FIG. 3A). A new text string layer may be provided by system 201 as a transparent text string layer, such that all graphical object content that was presented by any of the pre-existing layers may still be presented through the new top-most transparent text string layer (i.e., except for any portions of that pre-existing graphical object content that may be stacked directly underneath the text string graphical content of the new top-most transparent text string layer).

As mentioned, in some embodiments, system 201 may be configured to automatically or optionally provide certain types of graphical object layers with certain layer tools, while other types of graphical object layers may not be provided with those tools. For example, each text string graphical object layer may be provided with one or more tools, which may be similar to or different from those provided to image graphical object layers or to drawing shape graphical object layers. As shown in FIG. 3M, for example, when new text string layer 371 is initially presented on screen 300m, text string layer 371 may be presented along with one or more tools 372.

Rather than interacting with new text string layer 371 of screen 300m of FIG. 3M, a user may instead choose to selectively activate another graphical object layer of canvas 301. For example, as shown by screen 300n of FIG. 3N, a user may once again selectively activate image layer 331. As mentioned, system 201 may be configured to activate image layer 331 in response to receiving user selection input information 207 that may be indicative of a particular portion of layer 331 on canvas 301. For example, a user may identify a portion of drawing stroke graphical object 320a using a touch input gesture on touch screen 111 or via any point and click gesture of a mouse input component 110 (e.g., at position P1 on screen 300n within the expanded boundary of image layer 331, or at position P2 on screen 300n within the original boundary of image layer 331).

Once a user provides suitable selection input information 207 for identifying image layer 331, system 201 may be configured to activate that layer, such that a user may edit or manipulate that layer in one or more ways. For example, as shown by screen 300n of FIG. 3N, once image layer 331 has been selected, one or more layer tools 332 of layer 331 may be presented to the user and any other tools that may have been previously displayed for another layer may be removed (e.g., tools 372 of layer 371 may be removed). As mentioned, image layer tools 332 may include one or more control points 333 that may be positioned along boundary 334 of image layer 331 or at any other suitable position or positions associated with layer 331. In some embodiments, one control point 333 may be positioned at each corner of boundary 334 and one control point 333 may be positioned along each edge of boundary 334 between two corners. One or more of these control points 333 may be manipulated for stretching, shrinking, and/or moving image layer 331 in various ways along canvas 301.

For example, in some embodiments, a user may selectively activate a control point of a graphical object layer and then move that control point from its initial position on the canvas to a new position on the canvas, thereby stretching or shrinking at least some of the content of that layer. Any suitable input gesture or gestures on any suitable user input component or components may allow a user to generate selection input information 207 that system 201 may be configured to utilize for activating and moving one or more layer control points. For example, a touch pad or touch screen input component may allow a user to place a finger or cursor at the initial position of a control point and then drag the finger or cursor along canvas 301 in accordance with a user movement to a new position for that control point. For example, system 201 may be configured to move control point 333a of layer tools 332 in the direction of arrow M1 from its initial position P3 of FIG. 3N to a new position P4 of screen 300o of FIG. 3O. As shown in FIG. 3O, system 201 may be configured to update boundary 334 of selected image layer 331 based on this movement of control point 333a. Moreover, as shown in FIG. 3O, based on the updated boundary 334 of image layer 331, system 201 may be configured to re-render at least a portion of the graphical object content of image layer 331 accordingly. For example, as boundary 334 is stretched from its size of screen 300n to its size of screen 300o, at least a portion of image graphical object 330, at least a portion of drawing stroke graphical object 330a, and/or at least a portion of drawing stroke graphical object 330b may be stretched as well using any suitable approach.

As another example, in some embodiments, a user may selectively activate a non-control point of a graphical object layer and then move that entire graphical object layer from its initial position on the canvas to a new position on the canvas, thereby moving the content of that layer along the canvas of the display. Any suitable input gesture or gestures on any suitable user input component or components may allow a user to generate selection input information 207 that system 201 may be configured to utilize for activating and moving an entire graphical object layer. For example, a touch pad or touch screen input component may allow a user to place a finger or cursor at the initial position of a non-control point and then drag the finger or cursor along canvas 301 in accordance with a user movement to a new position for that non-control point. For example, system 201 may be configured to move a non-control point portion of drawing stroke 330a of image layer 331 in the direction of arrow M2 from its initial position P2 of FIG. 3N to a new position P5 of screen 300p of FIG. 3P. As shown in FIG. 3P, system 201 may be configured move the entirety of boundary 334 of selected image layer 331 based on this movement of a non-control point portion of layer 331. Moreover, as shown in FIG. 3P, based on the movement of boundary 334 of image layer 331, system 201 may be configured to re-render the graphical object content of image layer 331 accordingly. For example, as boundary 334 is moved from its position on canvas 301 of screen 300n to its position on canvas 301 of screen 300p, image graphical object 330, drawing stroke graphical object 330a, and drawing stroke graphical object 330b may also be moved accordingly using any suitable approach. In yet other embodiments, a particular portion of a graphical object layer may be moved or re-sized with respect to other portions of the layer. For example, a first graphical object of a layer may be moved or re-sized with respect to another graphical object of that same layer.

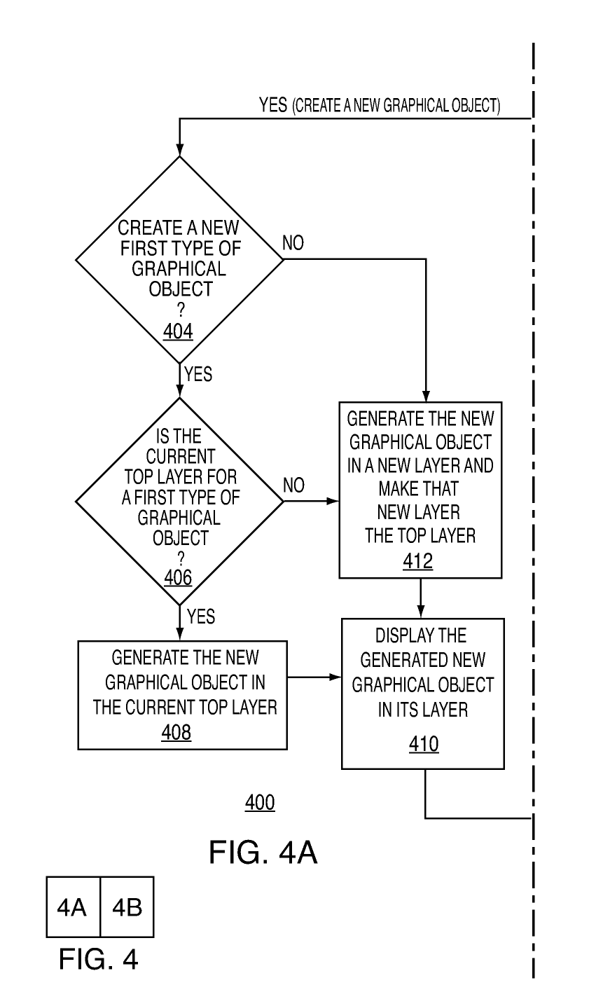

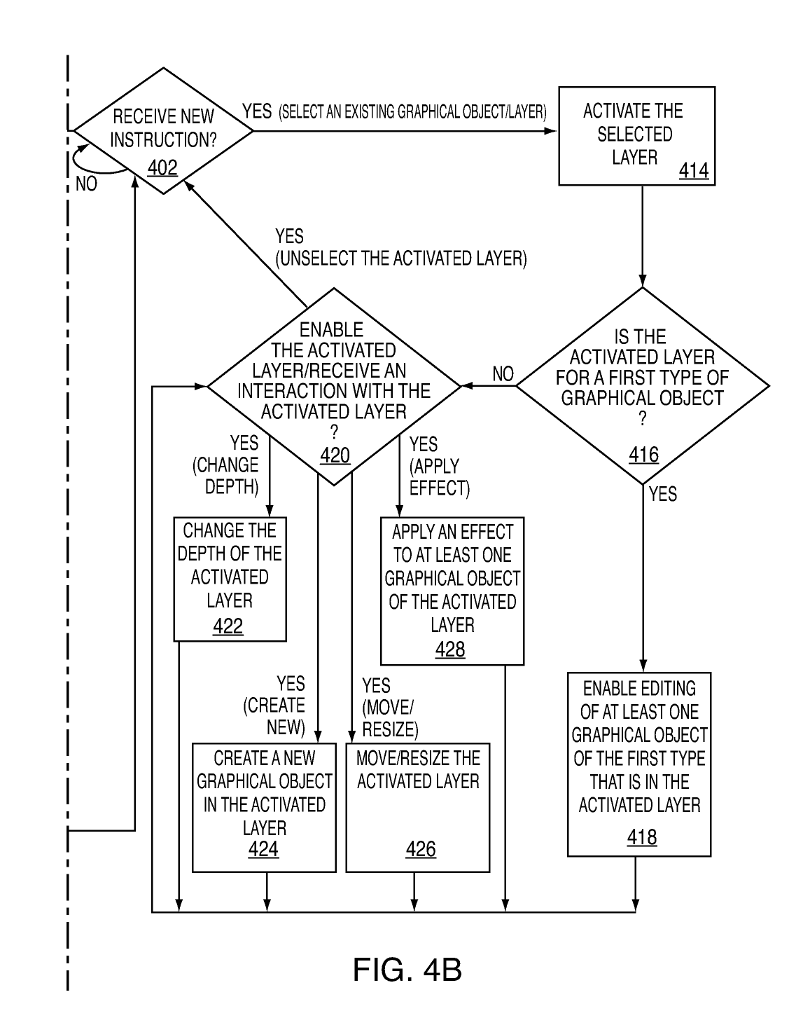

FIG. 4 is a flowchart of an illustrative process 400 for managing layers of graphical object data. Process 400 may begin at step 402 by receiving a new instruction. For example, a graphical display system, such as system 201 of FIG. 2, may be configured to receive various types of input instructions from one or more applications running on an electronic device or from one or more user input components (e.g., as input information 205 and 207) for generating and manipulating graphical objects on a display. The graphical objects may be provided by different layers of data, and each layer may be managed in a stack such that at least a portion of a layer higher up in the stack may be rendered over at least a portion of a layer lower down in the stack. For example, an instruction may be received at step 402 for creating a new graphical object and process 400 may then proceed to step 404. In some embodiments, such an instruction for creating a new graphical object may be received in response to a user selecting a specific menu option of an application that may provide a virtual canvas or workspace to a user (e.g., input options 312-318 of menu 310 of FIG. 3A). Although, in other embodiments, an instruction for creating a new graphical object may be received in any suitable way using any suitable user interface that may or may not include selectable menu options, but which may include specific input gestures associated with specific instructions independent of any visual menus or options.

At step 404, process 400 may determine what type of graphical object is to be created as the new graphical object. A graphical display system may be configured to generate various types of graphical objects (e.g., drawing stroke graphical objects, image graphical objects, drawing shape graphical objects, and text string graphical objects), and certain types of graphical objects may be generated differently than other types of graphical objects. Rather than explicitly creating and managing multiple graphical object layers, process 400 may utilize an implicit layer scheme that may be less confusing and less overwhelming to a casual user. For example, process 400 may be configured to determine whether to incorporate a new graphical object into a new layer or into a pre-existing layer based on the particular type of the new graphical object and/or based on the particular type of graphical object that may be provided by the current top-most layer.

For example, if it is determined at step 404 that the new graphical object to be created is a first type of graphical object, then process 400 may proceed to step 406. At step 406, process 400 may determine whether the current top-most layer in the stack is a layer that is for or otherwise associated with the first type of graphical object. In some embodiments, a layer may be associated with a particular type of graphical object if the layer was initially generated to include that particular type of graphical object. In other embodiments, a layer may be associated with a particular type of graphical object if the layer currently includes at least one graphical object of that particular type of graphical object. In other embodiments, a layer may be associated with a particular type of graphical object if the layer currently includes only that particular type of graphical object. For example, image layer 331 of FIG. 3K may be considered by process 400 to be associated with only an image type of graphical object because image layer 331 may have been initially generated to include image graphical object 330 (e.g., as described with respect to FIG. 3D). However, in other embodiments, image layer 331 of FIG. 3K may also be considered by process 400 to be associated with a drawing stroke type of graphical object because drawing stroke graphical object 330a may have been added into image layer 331 (e.g., as described with respect to FIG. 3J).

If it is determined at step 406 that the current top-most layer in the stack is a layer that is associated with the first type of graphical object, then process 400 may proceed to step 408. At step 408, process 400 may generate the new graphical object in the current top-most layer. For example, if the first type of graphical object includes a drawing stroke graphical object, if the new graphical object is a drawing stroke graphical object, and if the current top layer is associated with a drawing stroke graphical object, then the new drawing stroke graphical object may be generated in that current top-most layer at step 408. However, if it is determined at step 406 that the current top-most layer in the stack is a layer that is not associated with the first type of graphical object, then process 400 may proceed to step 412. Similarly, if it is determined at step 404 that the new graphical object is not a first type of graphical object (e.g., that the new graphical object is a second type of graphical object), then process 400 may proceed to step 412. At step 412, process 400 may generate the new graphical object in a new layer and may make that new layer the top-most layer in the stack. In some embodiments, steps 404 and/or 406 may be skipped, and step 402 may proceed directly to step 412 when an instruction to create a new graphical object is received, such that any new graphical object may be generated in a new layer and that new layer may be made the top layer in a stack regardless of whether the new graphical object is of a first or second type.

Therefore, process 400 may generate any new graphical object that is not of the first type in a new layer and may make that new layer the top-most layer in the layer stack. Moreover, unless the current top-most layer is associated with the first type of graphical object, process 400 may also generate any new graphical object in a new layer and may make that new layer the top-most layer. Therefore, only if the current top-most layer is associated with a first type of graphical object, may process 400 generate a new graphical object of the first type in that pre-existing current top-most layer. Accordingly, process 400 may generate any new graphical object of a first type of graphical object in a current top layer of a stack when the current top layer is associated with the first type of graphical object, may generate any new graphical object of the first type of graphical object in a new top layer of the stack when the current top layer of the stack is not associated with the first type of graphical object, and may generate any new graphical object of a second type of graphical object in a new top layer of the stack. This implicit handling of layer management may ensure that a user may never be confused by a layers list.

Once the new graphical object has been generated in a layer, either at step 408 or at step 412, process 400 may proceed to step 410 and the generated new graphical object may be presented for display in its layer. Moreover, in some embodiments, any appropriate tools associated with the layer of the new graphical object may be displayed at step 410. Additionally or alternatively, any previously displayed tools may be removed at step 410. Various types of tools may be displayed or otherwise provided or enabled when a new graphical object is displayed to a user. For example, when a new image graphical object is generated and displayed, one or more control points and/or one or more toolbar options may be provided to a user such that a user may edit or otherwise manipulate the new graphical object in various ways (see, e.g., tools 332 of FIG. 3D). After step 410, process 400 may return to step 402 and may await a new instruction.

In some embodiments, an instruction may be received at step 402 for selecting an existing graphical object or any other portion of an existing graphical object layer, and process 400 may then proceed to step 414. For example, such an instruction for selecting an existing graphical object or layer may be at least partially received in response to a user selecting a specific menu option of an application that may provide a virtual canvas or workspace to a user (e.g., content selection option 319 of menu 310 of FIG. 3G). Moreover, such an instruction for selecting an existing graphical object or layer may be at least partially received in response to a user pointing to or otherwise indicating a particular portion of a particular displayed graphical object or any other suitable portion of an existing graphical object layer (e.g., using a mouse or touch input component). Although, in some embodiments, instructions for selecting an existing graphical object or layer may be received in any suitable way using any suitable user interface, which may or may not include selectable menu options, but which may include specific input gestures associated with specific instructions independent of any visual menus or options.

At step 414, process 400 may activate the selected layer or may activate the layer of the selected existing graphical object. For example, process 400 may visually distinguish the activated layer or one or more graphical objects of the activated layer at step 414. In some embodiments, a layer may be visually distinguished from other layers on a display using any suitable visual effects, such as highlighting, blinking, and the like. For example, the boundary of a particular layer may be visually distinguished from other layers, or the boundary of at least one graphical object of a particular layer may be visually distinguished from the boundaries of other graphical objects of other layers. In some embodiments, one or more appropriate tools that may be associated with the activated layer may be displayed at step 414. Additionally or alternatively, any previously displayed tools may be removed from the display at step 414. As mentioned, by only presenting layer tools for a single particular layer (e.g., a currently activated layer) at a particular time, a user is less likely to be confused. For example, this may provide a more user-friendly interface for managing multiple graphical object layers.

Next, at step 416, process 400 may determine whether the activated layer is a layer that is for or otherwise associated with a first type of graphical object. In some embodiments, a layer may be deemed by step 416 to be associated with a particular type of graphical object if the layer was initially generated to include that particular type of graphical object. In other embodiments, a layer may be deemed by step 416 to be associated with a particular type of graphical object if the layer currently includes that particular type of graphical object. In other embodiments, a layer may be deemed by step 416 to be associated with a particular type of graphical object if the layer currently includes only that particular type of graphical object. If it is determined at step 416 that the activated layer is associated with a first type of graphical object, then process 400 may proceed to step 418.

At step 418, process 400 may enable a user to edit at least one graphical object of the first type that may be provided by the activated layer. For example, if a user selects drawing stroke graphical object 320 of drawing stroke layer 321 of FIG. 3F at step 402, if a drawing stroke graphical object is a first type of graphical object, and if drawing stroke graphical layer 321 is determined to be for a first type of graphical object at step 416, then process 400 may proceed to step 418 and a user may be enabled to edit at least one drawing stroke graphical object of activated layer 321 (e.g., at least one of drawing stroke graphical objects 320, 320a, and/or 320b). In some embodiments, a user may edit a drawing stroke graphical object by adding drawing strokes or erasing drawing strokes (e.g., as generally described with respect to FIGS. 3B and 3K, respectively).

In some embodiments, step 418 may enable a user to edit some or all portions of a single particular graphical object of the first type provided by the activated layer (e.g., a particular graphical object selectively identified at step 402). In other embodiments, step 418 may enable a user to edit every portion of every graphical object of the first type provided by the activated layer. In yet other embodiments, step 418 may enable a user to edit only those portions of every graphical object of the first type provided by the activated layer that may currently be visible on a display. For example, continuing with the example of FIG. 3F, if a user selects drawing stroke graphical object 320 of drawing stroke layer 321 of FIG. 3F at step 402, if a drawing stroke graphical object is determined to be a first type of graphical object, and if drawing stroke graphical layer 321 is determined to be for a first type of graphical object at step 416, then process 400 may proceed to step 418 and a user may be enabled to edit every portion of drawing stroke graphical objects 320, 320a, and 320b of activated layer 321. Alternatively, step 418 may enable a user to edit only those portions of drawing stroke graphical objects 320, 320a, and/or 320b that are visible (e.g., not covered by image content 330 of layer 331 and not covered by drawing stroke content 350 of layer 351). In yet other embodiments, step 418 may enable a user to edit only portions of drawing stroke graphical object 320 if drawing stroke graphical objet 320 was specifically selected at step 402. After step 418, process 400 may return to step 402. In some embodiments, step 418 may only enable editing of at least one graphical object of the activated layer if the activated layer is the current top-most layer in a stack.

However, if it is determined at step 416 that the activated layer is not associated with a first type of graphical object, then process 400 may proceed to step 420. At step 420, process 400 may enable a user to manipulate the activated layer in one of various ways. For example, at step 420, one or more particular types of interaction with the activated layer may be detected for manipulating the activated layer. For example, a graphical display system, such as system 201 of FIG. 2, may be configured to receive various types of input instructions from one or more applications running on an electronic device or from one or more user input components (e.g., as input information 205 and 207) for determining particular interactions with an activated graphical object layer. In some embodiments, when process 400 proceeds to step 420, at least one tool associated with the activated layer may be presented on a display. This may be in addition to or instead of any tools that may be presented at step 414. For example, based on the determination at step 416 that the activated layer is not for a first type of graphical object, process 400 may present at least on layer tool at step 420 (e.g., before any interaction with the activated layer is received). At step 420, the activated layer may be enabled for various types of manipulation and/or editing.

In some embodiments, an interaction may be received for creating a new graphical object in the activated layer at step 420, and process 400 may proceed to step 422. Accordingly, at step 422, a new graphical object may be created in the activated layer. For example, as described with respect to FIGS. 3J and 3K, a drawing stroke graphical object may be added to an activated image layer (e.g., in response to a user interaction with one or more toolbar tools). In some embodiments, a new graphical object that may be created in the activated layer at step 422 may be made an integral part of the activated layer, such that when the activated layer is manipulated, the new graphical object may be manipulated. For example, when the activated layer is moved with a layer stack or along a display, the new graphical object may be moved with the activated layer. Process 400 may return to step 420 after step 422.

In other embodiments, an interaction may be received for changing the depth of the activated layer at step 420, and process 400 may proceed to step 424. Accordingly, at step 424, the depth of the activated layer may be changed. For example, as described with respect to FIGS. 3G-3I, the depth of a selected graphical object layer may be moved up or down in a layer stack (e.g., in response to a user interaction with one or more toolbar tools). If a new graphical object has been added to the activated layer at step 422, then step 424 may move that new graphical object along with other graphical object content of the activated layer within the stack. Process 400 may return to step 420 after step 424.

In yet other embodiments, an interaction may be received for moving or resizing at least a portion of the activated layer at step 420, and process 400 may proceed to step 426. Accordingly, at step 426, at least a portion of the activated layer may be moved or resized along a display. For example, as described with respect to FIGS. 3N-3P, an activated layer may be stretched or moved (e.g., in response to a user interaction with one or more control point locations or non-control point locations of the layer). If a new graphical object has been added to the activated layer at step 422, then step 426 may move or resize that new graphical object along with other graphical object content of the activated layer along a display. Process 400 may return to step 420 after step 426.

In yet other embodiments, an interaction may be received for applying an effect to at least a portion of the activated layer at step 420, and process 400 may proceed to step 428. Accordingly, at step 428, an effect may be applied to at least a portion of the activated layer. For example, a particular graphical object of the activated layer or the entire activated layer itself may be edited in any suitable way by the application of an effect. An effect nay be applied to crop, rotate, shade, or otherwise alter graphical object content of a layer (e.g., in response to a user interaction with one or more toolbar tools). If a new graphical object has been added to the activated layer at step 422, then step 428 may apply an effect to that new graphical object along with other graphical object content of the activated layer. Process 400 may return to step 420 after step 428. Moreover, step 420 may return to step 402 in response to an interaction indicative of the activated layer being unselected or deactivated in some way.

This implicit handling of layer management of process 400 may ensure that a user may never be put in a situation where he or she tries to create a first type of graphical object content but an input tool for the first type of graphical object content does not work because a layer that is incompatible with the first type of graphical content has been selected. Therefore, a graphical display system, such as system 201, may be configured to follow one or more rules or principles when defining, selecting, and/or managing various graphical object layers, such that the simplicity of a basic drawing space application may be combined with the flexibility and non-destructive manipulation capabilities of a more advanced layering application.

It is to be understood that any suitable type or types of graphical object may be deemed a first type of graphical object for the purposes of process 400. For example, in some embodiments, only drawing stroke graphical objects may be a first type of graphical object. In other embodiments, only text string graphical objects may be a first type of graphical object. In yet other embodiments, both drawing stroke graphical objects and text string graphical objects may be a first type of graphical object. Any type or types of graphical object may be considered a first type or a second type according to different embodiments. For example, system 201 may be configured according to various settings to define various types of graphical objects.

Moreover, as mentioned, various factors may be used to determine whether a particular layer may be deemed for or otherwise associated with a first type of graphical object. For example, a layer may be deemed to be associated with a particular type of graphical object if the layer was initially generated to include that particular type of graphical object, if the layer currently includes that particular type of graphical object, or if the layer currently includes only that particular type of graphical object. It is to be understood that the factors for this determination may differ between step 406 and step 416 of process 400.

It is to be understood that the steps shown in process 400 of FIG. 4 is merely illustrative and that existing steps may be modified or omitted, additional steps may be added, and the order of certain steps may be altered.

Moreover, the processes described with respect to FIG. 4, as well as any other aspects of the invention, may each be implemented by software, but may also be implemented in hardware, firmware, or any combination of software, hardware, and firmware. They each may also be embodied as computer-readable code recorded on a computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices (e.g., memory 104 of FIG. 1). The computer-readable medium can also be distributed over network-coupled computer systems so that the computer readable code is stored and executed in a distributed fashion. For example, the computer-readable medium may be communicated from one electronic device to another electronic device using any suitable communications protocol (e.g., the computer-readable medium may be communicated to electronic device 100 via communications circuitry 106). The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that each module of graphical display system 201 may be provided as a software construct, firmware construct, one or more hardware components, or a combination thereof. For example, graphical display system 201 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of graphical display system 201 are merely illustrative, and that the number, configuration, functionality, and interconnection of existing modules may be modified or omitted, additional modules may be added, and the interconnection of certain modules may be altered.

At least a portion of one or more of the modules of system 201 may be stored in or otherwise accessible to device 100 in any suitable manner (e.g., in memory 104 of device 100 or via communications circuitry 106 of device 100). Each module of system 201 may be implemented using any suitable technologies (e.g., as one or more integrated circuit devices), and different modules may or may not be identical in structure, capabilities, and operation. Any or all of the modules or other components of system 201 may be mounted on an expansion card, mounted directly on a system motherboard, or integrated into a system chipset component (e.g., into a “north bridge” chip). System 201 may include any amount of dedicated graphics memory, may include no dedicated graphics memory and may rely on device memory 104 of device 100, or may use any combination thereof.

Graphical display system 201 may be a dedicated system implemented using one or more expansion cards adapted for various bus standards. For example, all of the modules may be mounted on different interconnected expansion cards or all of the modules may be mounted on one expansion card. The modules of system 201 may interface with a motherboard or processor 102 of device 100 through an expansion slot (e.g., a peripheral component interconnect (“PCI”) slot or a PCI express slot). Alternatively, system 201 need not be removable but may include one or more dedicated modules that may include memory (e.g., RAM) dedicated to the utilization of the module. In other embodiments, system 201 may be a graphics system integrated into device 100. For example, a module of system 201 may utilize a portion of device memory 104 of device 100. One or more of the modules of graphical display system 201 may include its own processing circuitry and/or memory. Alternatively each module of graphical display system 201 may share processing circuitry and/or memory with any other module of graphical display system 201 and/or processor 102 and/or memory 104 of device 100.

As mentioned, an input component 110 of device 100 may include a touch input component that can receive touch input for interacting with other components of device 100 via wired or wireless bus 114. Such a touch input component 110 may be used to provide user input to device 100 in lieu of or in combination with other input components, such as a keyboard, mouse, and the like. One or more touch input components may be used for providing user input to device 100.

A touch input component 110 may include a touch sensitive panel, which may be wholly or partially transparent, semitransparent, non-transparent, opaque, or any combination thereof. A touch input component 110 may be embodied as a touch screen, touch pad, a touch screen functioning as a touch pad (e.g., a touch screen replacing the touchpad of a laptop), a touch screen or touch pad combined or incorporated with any other input device (e.g., a touch screen or touch pad disposed on a keyboard), or any multi-dimensional object having a touch sensitive surface for receiving touch input. In some embodiments, the terms touch screen and touch pad may be used interchangeably.

In some embodiments, a touch input component 110 embodied as a touch screen may include a transparent and/or semitransparent touch sensitive panel partially or wholly positioned over at least a portion of a display (e.g., display 112). In other embodiments, a touch input component 110 may be embodied as an integrated touch screen where touch sensitive components/devices are integral with display components/devices. In still other embodiments, a touch input component 110 may be used as a supplemental or additional display screen for displaying supplemental or the same graphical data as a primary display and to receive touch input.

A touch input component 110 may be configured to detect the location of one or more touches or near touches based on capacitive, resistive, optical, acoustic, inductive, mechanical, chemical measurements, or any phenomena that can be measured with respect to the occurrences of the one or more touches or near touches in proximity to input component 110. Software, hardware, firmware, or any combination thereof may be used to process the measurements of the detected touches to identify and track one or more gestures. A gesture may correspond to stationary or non-stationary, single or multiple, touches or near touches on a touch input component 110. A gesture may be performed by moving one or more fingers or other objects in a particular manner on touch input component 110, such as by tapping, pressing, rocking, scrubbing, rotating, twisting, changing orientation, pressing with varying pressure, and the like at essentially the same time, contiguously, or consecutively. A gesture may be characterized by, but is not limited to, a pinching, sliding, swiping, rotating, flexing, dragging, or tapping motion between or with any other finger or fingers. A single gesture may be performed with one or more hands, by one or more users, or any combination thereof.

As mentioned, electronic device 100 may drive a display (e.g., display 112) with graphical data to display a graphical user interface (“GUI”). The GUI may be configured to receive touch input via a touch input component 110. Embodied as a touch screen (e.g., with display 112 as I/O component 111), touch I/O component 111 may display the GUI. Alternatively, the GUI may be displayed on a display (e.g., display 112) separate from touch input component 110. The GUI may include graphical elements displayed at particular locations within the interface. Graphical elements may include, but are not limited to, a variety of displayed virtual input devices, including virtual scroll wheels, a virtual keyboard, virtual knobs, virtual buttons, any virtual UI, and the like. A user may perform gestures at one or more particular locations on touch input component 110, which may be associated with the graphical elements of the GUI. In other embodiments, the user may perform gestures at one or more locations that are independent of the locations of graphical elements of the GUI. Gestures performed on a touch input component 110 may directly or indirectly manipulate, control, modify, move, actuate, initiate, or generally affect graphical elements, such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad may generally provide indirect interaction. Gestures may also affect non-displayed GUI elements (e.g., causing user interfaces to appear) or may affect other actions of device 100 (e.g., affect a state or mode of a GUI, application, or operating system). Gestures may or may not be performed on a touch input component 110 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments, in which gestures are performed directly on a touch screen, a user may interact directly with objects on the touch screen, with or without a cursor or pointer being displayed on the touch screen.

Feedback may be provided to the user via bus 114 in response to or based on the touch or near touches on a touch input component 110. Feedback may be transmitted optically, mechanically, electrically, olfactory, acoustically, or the like or any combination thereof and in a variable or non-variable manner.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A method for managing graphical object data comprising:
determining the type of a new graphical object to be generated; and
generating the new graphical object in response to the determining, the generating comprising:
in response to determining that the new graphical object is a second type of graphical object, generating the new graphical object in a new layer and positioning the new layer at the top of a stack;
in response to determining that the new graphical object is a first type of graphical object, determining if the top layer in the stack is associated with the first type of graphical object;
in response to determining that the top layer in the stack is associated with the first type of graphical object, generating the new graphical object in the top layer in the stack; and
in response to determining that the top layer in the stack is not associated with the first type of graphical object, generating the new graphical object in a new layer and positioning the new layer at the top of the stack.

2. The method of claim 1, wherein the first type of graphical object comprises a drawing stroke graphical object.

3. The method of claim 1, wherein the second type of graphical object comprises an image graphical object.

4. The method of claim 1, wherein:
the first type of graphical object comprises a drawing stroke graphical object; and
the second type of graphical object comprises an image graphical object.

5. The method of claim 1, wherein the determining that the top layer in the stack is associated with the first type of graphical object comprises determining that the top layer in the stack was initially generated to include an initial graphical object of the first type of graphical object.

6. The method of claim 1, wherein the determining that the top layer in the stack is associated with the first type of graphical object comprises determining that the top layer in the stack comprises an existing graphical object of the first type of graphical object.

7. The method of claim 1, wherein the determining that the top layer in the stack is associated with the first type of graphical object comprises:
determining that the top layer in the stack comprises at least one existing graphical object; and
determining that each of the at least one existing graphical objects is of the first type of graphical object.

8. The method of claim 1 further comprising presenting the generated new graphical object in its layer on a display.

9. The method of claim 8 further comprising removing at least one previously presented layer tool from the display.

10. The method of claim 8 further comprising, in response to determining that the new graphical object is the second type of graphical object, presenting on the display at least one new layer tool that is associated with the layer of the new graphical object.

11. A method for managing graphical object data comprising:
presenting a plurality of graphical object layers in a stack on a display;
receiving a selection of a first graphical object layer of the plurality of graphical object layers;
determining if the first graphical object layer is associated with a first type of graphical object; and
enabling the first graphical object layer based on the determining.

12. The method of claim 11 further comprising activating the first graphical object layer before the enabling.

13. The method of claim 12, wherein the activating comprises removing at least one previously presented layer tool from the display.

14. The method of claim 12, wherein the activating comprises visually distinguishing the first graphical object layer from the other graphical object layers of the plurality of graphical object layers on the display.

15. The method of claim 11, wherein:
the first graphical object layer comprises at least one graphical object of the first type of graphical object; and
in response to determining that the first graphical object layer is associated with the first type of graphical object, the enabling comprises enabling the editing of the at least one graphical object of the first type of graphical object.

16. The method of claim 11, wherein:
the first graphical object layer comprises at least one graphical object of the first type of graphical object; and
in response to determining that the first graphical object layer is associated with the first type of graphical object, and in response to determining that the first graphical object layer is the top layer in the stack, the enabling comprises enabling the editing of the at least one graphical object of the first type of graphical object.

17. The method of claim 11, wherein:
the first graphical object layer comprises at least one graphical object; and
in response to determining that the first graphical object layer is not associated with the first type of graphical object, the enabling comprises presenting on the display at least one layer tool that is associated with the first graphical object layer.

18. The method of claim 17, wherein the presenting comprises presenting the at least one layer tool in the top layer in the stack.

19. The method of claim 17, wherein the presenting comprises enabling the first graphical object layer to be actively moved along the stack.

20. The method of claim 17, wherein the presenting comprises enabling the first graphical object layer to be actively moved along the display.

21. The method of claim 17, wherein the presenting comprises enabling a new graphical object to be created in the first graphical object layer.

22. The method of claim 21, wherein:
the first graphical object layer comprises an initial boundary; and
the enabling the new graphical object to be created comprises enabling the new graphical object to be created within the initial boundary.

23. The method of claim 21, wherein:
the first graphical object layer comprises an initial boundary; and
the enabling the new graphical object to be created comprises enabling the new graphical object to be created beyond the initial boundary.

24. The method of claim 11, wherein the determining that the first graphical object layer is associated with the first type of graphical object comprises determining that the first graphical object layer was initially generated to include an initial graphical object of the first type of graphical object.

25. The method of claim 11, wherein the determining that the first graphical object layer is associated with the first type of graphical object comprises determining that the first graphical object layer comprises an existing graphical object of the first type of graphical object.

26. The method of claim 11, wherein the determining that the first graphical object layer is associated with the first type of graphical object comprises:
determining that the first graphical object layer comprises at least one graphical object; and
determining that each of the at least one graphical objects is of the first type of graphical object.

27. A method for managing graphical object data comprising:
presenting a plurality of graphical object layers in a stack on a display;
receiving a selection of a first graphical object layer of the plurality of graphical object layers, the first graphical object layer comprising a first graphical object;
creating a new graphical object in the selected first graphical object layer; and
manipulating the first graphical object layer, wherein the manipulating the first graphical object layer comprises manipulating the first graphical object and the new graphical object.

28. The method of claim 27, wherein:
the first graphical object comprises an image graphical object; and
the new graphical object comprises a drawing stroke graphical object.

29. The method of claim 28, wherein the creating the new graphical object comprises re-defining a portion of the first graphical object layer previously defined by the first graphical object.

30. The method of claim 28, wherein the creating the new graphical object comprises expanding a boundary of the first graphical object layer.

31. The method of claim 27, wherein:
the manipulating further comprises moving the first graphical object layer along the stack; and
the moving comprises moving the first graphical object and the new graphical object with the first graphical object layer along the stack.

32. The method of claim 27, wherein:
the manipulating further comprises moving the first graphical object layer along the display; and
the moving comprises moving the first graphical object and the new graphical object with the first graphical object layer along the display.

33. The method of claim 27, wherein:
the manipulating further comprises resizing the first graphical object layer; and
the resizing comprises resizing the first graphical object and the new graphical object with the first graphical object layer.

34. A graphical display system comprising:
a graphical object generating module that:
receives input information defining a new graphical object to be generated;
determines if the new graphical object to be generated is a first type of graphical object based on the received input information;
generates a new top layer in a stack and generates the new graphical object in the new top layer when the generating module determines that the new graphical object is not of the first type;
determines if the current top layer in the stack is associated with the first type of graphical object when the generating module determines that the new graphical object is of the first type;
generates the new graphical object in the current top layer when the generating module determines that the current top layer is associated with the first type of graphical object; and
generates a new top layer in the stack and generates the new graphical object in the new top layer when the generating module determines that the current top layer is not associated with the first type of graphical object; and
a graphical processing module that renders the generated new graphical object in its layer on a display.

35. Computer-readable media for controlling an electronic device, comprising computer-readable code recorded thereon for:
generating any new graphical object of a first type of graphical object in a current top layer of a stack when the current top layer is associated with the first type of graphical object;
generating any new graphical object of the first type of graphical object in a new top layer of the stack when the current top layer of the stack is not associated with the first type of graphical object; and
generating any new graphical object of a second type of graphical object in a new top layer of the stack.
